(19) United States
(12) Patent Application Publication
(10) Pub. No.: US 2026/0236877 A1
(43) Pub. Date: Aug. 13, 2026

(54) SYSTEMS AND METHODS FOR EVALUATING AGRICULTURAL SUSTAINABILITY METRICS

(71) Applicant: Farm Credit Canada, Regina (CA)

(72) Inventors: Shakila Kalhari Thilakarathna EKANAYAKA MUDIYANSELAGE, Edmonton (CA); Bryan PRYSTUPA, Regina (CA); Darcy HERAUF, Regina (CA)

(21) Appl. No.: 19/048,462

(22) Filed: Feb. 7, 2025

(51) Int. Cl. G06Q 10/0639; G06Q 50/02

(52) U.S. Cl. CPC G06Q 10/06395; G06Q 50/02

(57) ABSTRACT

Systems, methods, and techniques are disclosed for evaluating agricultural sustainability metrics, in particular for evaluating sustainability metrics of a farm using a variety of data sources. A method for evaluating a sustainability metric of a farm comprises: receiving, from a user device, one or more first data inputs associated with the farm; obtaining, from an external device via an application programming interface, one or more second data inputs associated with the farm; and obtaining, from a third party data source, one or more third data inputs associated with the farm. Using at least one sustainability calculation model, one or more sustainability metrics of the farm are calculated based on the one or more first data inputs, the one or more second data inputs, and the one or more third data inputs. The one or more sustainability metrics are output for display on the user device.

### TECHNICAL FIELD

The present disclosure relates to systems and methods for evaluating agricultural sustainability metrics, and in particular to evaluating sustainability metrics of a farm using a variety of data sources.

### BACKGROUND

As global awareness of climate change and environmental sustainability grows, there is an increasing demand for accurate and comprehensive tools to assess the carbon footprint and overall sustainability of products and processes, particularly in the field of agriculture.

Existing frameworks and models to measure, analyze and monitor sustainability have been grounded in academic or theoretical understanding of the industry, resulting in complex, exhaustive, data-intensive methodologies that deter farmers from understanding or using such models. When farmers manually enter their data to run the model(s), if they don't understand how the model works and if they miss important steps, the output can be inaccurate. Moreover, when farmers record their data elsewhere and then enter that data in a separate platform to estimate emissions and sequestration, there is risk of human-error during data entry and running the model. Additionally, when a farmer wants to locate their farm in these platforms, the locations are often not exact which can lead to errors in weather and soil data. Further, such existing frameworks and models often rely on a vast amount of default data due the limitations of using real farm data across a range of farms and locations, in addition to the manually entered data input by farmers. Ultimately, the quality and amount of input data is limited, and the outputs from existing models tend to be inaccurate and/or incomplete and thus are ineffective for use by stakeholders to understand, analyze, and inform their sustainability efforts.

Accordingly, additional, alternative, and/or improved systems, methods, and techniques for evaluating agricultural sustainability metrics of a farm remain highly desirable.

### SUMMARY

In accordance with one aspect of the present disclosure, a method for evaluating a sustainability metric of a farm is disclosed, comprising: receiving, from a user device, one or more first data inputs associated with the farm; obtaining, from an external device via an application programming interface, one or more second data inputs associated with the farm; obtaining, from a third party data source, one or more third data inputs associated with the farm; calculating, using at least one sustainability calculation model, one or more sustainability metrics of the farm based on the one or more first data inputs, the one or more second data inputs, and the one or more third data inputs; and outputting the one or more sustainability metrics for display on the user device.

In some aspects, the at least one sustainability calculation model comprises: a carbon sequestration model, a N2O emission model, a CO2 emission model, a CH4 emission model, or a combination thereof; and wherein the one or more sustainability metrics is one or more of a carbon sequestration, a N2O emission, a CO2 emission, and a CH4 emission of the farm.

In some aspects, the method further comprises: calculating a carbon balance for the farm based on the carbon sequestration, the N2O emission, the CO2 emission, and the CH4 emission.

In some aspects, the method further comprises standardizing the one or more first data inputs, the one or more second data inputs, and/or the one or more third data inputs by mapping input data types to a standardized data type for use in the at least one sustainability calculation model.

In some aspects, the one or more first data inputs comprise manually entered data and/or imported data.

In some aspects, the one or more first data inputs comprise: agriculture activity data, crop field data, crop data, livestock data, or combinations thereof.

In some aspects, the method further comprises determining a suggested improvement that a user can make to the one or more first data inputs, and outputting the suggested improvement for display on the user device prior to calculating the one or more sustainability metrics.

In some aspects, determining the suggested improvement comprises: identifying one or more missing values from the first data inputs; and prompting the user to input the one or more missing values.

In some aspects, determining the suggested improvement comprises: comparing the one or more first data inputs to pre-defined threshold values; and prompting the user to revise a value of the one or more first data inputs when the value is determined to be outside the pre-defined threshold values.

In some aspects, the external device comprises: farm equipment, a vehicle, a satellite, a sensor, an Internet of Things (IoT) device, a third party computing device, or combinations thereof.

In some aspects, the one or more second data inputs comprises: fuel data, weather data, soil data, or combinations thereof.

In some aspects, the one or more third data inputs comprise: crop product data, seed product data, legal land descriptions, or combinations thereof.

In some aspects, the method further comprises: storing the one or more sustainability metrics in a database; generating trend data of the one or more sustainably metrics for the farm over time; and outputting the trend data for display on the user device.

In some aspects, the method further comprises: retrieving stored sustainability metrics of similar farms; generating benchmarking data by comparing the one or more sustainability metrics of the farm against the sustainability metrics of similar farms; and outputting the benchmarking data for display on the user device.

In some aspects, the second data inputs and the third data inputs are obtained automatically.

In accordance with another aspect of the present disclosure, a system for evaluating a sustainability metric of a farm is disclosed, comprising: a processor; and a non-transitory computer-readable medium having computer-executable instructions stored thereon which, when executed by the processor, configure the system to perform the method of any one of the above aspects.

In some aspects, the system further comprises a database storing the one or more sustainability metrics calculated for the farm.

In some aspects, the database further stores the one or more first data inputs, the one or more second data inputs, and the one or more third data inputs.

In some aspects, the database further stores sustainability metrics for a plurality of farms.

In accordance with another aspect of the present disclosure, a non-transitory computer-readable medium having computer-executable instructions stored thereon is disclosed which, when executed by a processor, configure the processor to perform the method of any one of the above aspects.

### BRIEF DESCRIPTION OF THE DRAWINGS

Further features and advantages of the present disclosure will become apparent from the following detailed description, taken in combination with the appended drawings, in which:

FIG. 1A shows a system for evaluating a sustainability metric of a farm in accordance with the present disclosure;

FIG. 1B shows a data flow diagram using the system;

FIG. 2 shows a representation of an architecture of the system;

FIG. 3 shows a representation of standardizing data inputs;

FIG. 4A shows a flow diagram of how data is collected, processed, and stored for evaluating a sustainability metric of a farm;

FIG. 4B shows a flow diagram providing an example of how a user inputs data to the system;

FIG. 5 shows a flow diagram of how different models are used for evaluating a sustainability metric of a farm;

FIG. 6 shows a flow diagram for evaluating a sustainability metric of a farm;

FIG. 7 shows a flow diagram for evaluating carbon dioxide emissions of a farm;

FIG. 8 shows a flow diagram for benchmarking a sustainability metric of a farm;

FIG. 9 shows a method for evaluating a sustainability metric of a farm;

and

FIGS. 10A-O show examples of user interfaces that may be displayed to a user using the system.

It will be noted that throughout the appended drawings, like features are identified by like reference numerals.

### DETAILED DESCRIPTION

Systems, methods, and techniques are disclosed herein for evaluating agricultural sustainability metrics, in particular for evaluating sustainability metrics of a farm using a variety of data sources.

In accordance with at least some aspects of the present disclosure, a method for evaluating a sustainability metric of a farm comprises: receiving, from a user device, one or more first data inputs associated with the farm; obtaining, from an external device via an application programming interface, one or more second data inputs associated with the farm; and obtaining, from a third party data source, one or more third data inputs associated with the farm. Using at least one sustainability calculation model, one or more sustainability metrics of the farm are calculated based on the one or more first data inputs, the one or more second data inputs, and the one or more third data inputs. The one or more sustainability metrics are output for display on the user device.

The systems, methods, and techniques disclosed herein can provide farmers with accurate estimations of various sustainability metrics for their farm, including carbon sequestration, carbon dioxide (CO₂), nitrous oxide (N₂O), and methane (CH₄) emissions. Advantageously, the systems, methods, and techniques disclosed herein can ingest and process a large amount of input data from a variety of data sources, some of which users may already be tracking but are not being analyzed, to enhance the accuracy of model calculations while also minimizing manual user inputs. Moreover, the sustainability calculation model(s) used to calculate the sustainability metrics disclosed herein are not limited to any particular sustainability calculation model, and can be implemented using models that are updated frequently and/or are most up-to-date based on new research findings.

Compared to existing tools and models that rely heavily on default data due the limitations of using real farm data across range of farms and locations, the systems, methods, and techniques disclosed herein collect and utilize actual, specific farm data for better accuracy and relevancy to the user. With this approach, data better reflects the exact amount of inputs and the timing of farm activities. Further, in accordance with the systems, methods, and techniques disclosed herein, data can be automatically obtained, and potential inaccuracies are avoided from incorrect farm location and manual data entry.

Accordingly, the systems, methods, and techniques in accordance with the present disclosure enable farmers to better assess their environmental impact, validate their sustainability practices, and identify potential improvements. Moreover, a carbon dioxide equivalency (CO₂ₑ) rating for a particular farm operation may be provided. It is therefore possible to enhance farm management practices and industry value by using the disclosed systems and methods to estimate various sustainability metrics related to carbon sequestration and greenhouse gas (GHG) emissions, which can support farmers, industry, and government in understanding and agricultural practices for an array of upstream and downstream benefits for the entire agriculture-food value chain.

As described above and in more detail below, there are four main modules (C; CO₂; N₂O; CH₄) provided by the system that can be used to estimate their respective sequestration/emissions individually, and, when combined, provide a whole-operation sustainability footprint (CO₂e). A general overview of these modules is described as follows.

### (1) Estimating Carbon Sequestration

Sequestering carbon: The system streamlines and simplifies the model calculation of soil organic carbon and carbon sequestration by utilizing farm production data users would already be tracking.

Data Integration: Instead of starting from scratch, users can re-use data and information they are already tracking across their trusted tools. Regardless of data source, this module calculates carbon sequestration based on GPS location, soil type, weather, crop type, tillage, manure application and harvest activities.

Centralization and Standardization: With the complexity with integrating data from many different technologies and device types, the system ingests the data and standardizes it in a way that the model needs in order to give accurate soil carbon outputs.

Validation: Farmers have a low-touch, low-cost and extremely accessible method to validate and prove the carbon sequestration of their operation.

Informed Decisions: This supports farmers in making more informed decisions to assess their overall sequestration performance while drilling into metadata on specific fields, locations or crop varieties that sequester more carbon than others.

### (2) Estimating CO₂ Emissions by Fuel Usage

Scope 1-3 Emissions: The system streamlines and simplifies the calculation of Scope 1-3 CO₂ emissions for farms by utilizing fuel usage data users may already be tracking.

Data Integration: The system leverages fossil fuel data (i.e. type; volume; usage) and possibly all fuel types (e.g. energy), which can be entered manually by farmers or automatically imported from various sources such as farm equipment, input providers, cardlocks, and other fuel data sources.

Centralization and Standardization: By centralizing and standardizing this data within the platform, farmers can easily and accurately estimate their CO₂, including direct (Scope 1) and indirect (Scope 2) CO₂ emissions.

Informed Decisions: This streamlined approach not only enhances the accuracy of CO₂ emissions reporting but also supports farmers in making informed decisions to improve their sustainability practices.

### (3) Estimating N₂O Emissions

Scope 1-3 Emissions: The systems streamlines and simplifies the calculation of Scope 1-3 N₂O emissions for farms by utilizing farm production data users may already be tracking.

Data Integration: Instead of starting from scratch, users can re-use data and information they are already tracking across their trusted tools. Regardless of data source, this module calculates N₂O emissions based on synthetic (conventional and enhanced efficiency N fertilizers) and organic N fertilizer applications (manure), crop residue N inputs, mineralization, volatilization, leaching and runoff.

Centralization and Standardization: With the complexity with integrating data from many different technologies and device types, the system ingests the data and standardizes it in a way that the model needs in order to give accurate N₂O emission outputs.

Validation: Farmers have a low-touch, low-cost and extremely accessible method to validate and prove how much N₂O is being emitted on their operation.

Informed Decisions: This supports farmers in making more informed decisions to assess their overall N₂O emissions while getting reporting on the impacts of enhanced efficiency fertilizers and different application methods. Furthermore, they are able to drill into metadata on specific fields, locations or crop varieties.

### (4) Estimating CH₄ Emissions

Scope 1-3 Emissions: The systems streamlines and the calculation of Scope 1-3 CH₄ emissions for farms by utilizing farm production data users may already be tracking.

Data Integration: Instead of starting from scratch, users can re-use data and information they are already tracking across their trusted tools. Regardless of data source, this module calculates CH₄ emissions based on livestock types, weight classes, grades, animal diet, animal housing and manure applications.

Centralization and Standardization: With the complexity with integrating data from many different technologies and device types, the system ingests the data and standardizes it in a way that the model needs in order to give accurate CH₄ emission outputs.

Validation: Farmers have a low-touch, low-cost and extremely accessible method to validate and prove how much CH₄ is not only being emitted but offset on their operation.

Informed Decisions: This supports producers in making more informed decisions to assess their overall CH₄ emissions while getting reporting on the offsetting impacts of land lifecycles. Furthermore, they are able to drill into metadata on specific animals, different animal lifecycle stages, diets and housing types.

### (5) Estimating Whole-Operation CO₂ₑ Balance

Combine all four modules for a net balance output: When all CO₂, N₂O and CH₄ emissions are subtracted from carbon sequestration C, the system is able to provide users with an all-encompassing, low-touch, high-value overview of their operation's sustainability footprint.

By utilizing the disclosed systems, methods, and techniques for evaluating a sustainability metric of a farm, various downstream benefits and impacts can be derived. Some benefits may be financial, such as nature-based financing, for example in cases where financial institutions can offer better loan terms and investment opportunities to farms demonstrating strong sustainability metrics. Users such as financial institutions, farmers, and equipment providers can also have the ability to assess marginal abatement costs and return on investment. Further, by accurately estimating carbon sequestration and emissions, users can have practical data outputs that can be sold to organizations looking to offset their own carbon footprint. Other benefits may be environmental or operational, for example in achieving climate smart agriculture. The sustainability analysis performed by the disclosed systems and methods can help users develop and implement strategies to adapt to changing climate conditions, ensuring long-term sustainability and profitability. It is also possible to ensure resilient practices by using the disclosed systems and methods to support the adoption of climate-smart agricultural practices, such as crop rotation, cover cropping and reduced tillage, which enhance soil health and resilience to climate change. By using the results of the sustainability analysis, users can optimize resource use (e.g., irrigation, fertilizers; crop protection) and reduce their environmental impact while maintaining or increasing productivity and decreasing their input costs.

It will thus be appreciated that various stakeholders can benefit from the systems, methods, and techniques disclosed herein, with benefits including but not limited to:
improving farmer knowledge and literacy in relation to operational sustainability; enhancing the decision-making of the farmers with regard to environmental and economic impacts and validate sustainable practices, and enabling on farm-sustainability practices with tangible, verifiable data;
providing agronomists with enhanced recommendations related to the sustainability metrics of their clients' farms;
providing food processors with traceability assurances in sourcing products with sustainable production practices;
providing land lease companies with traceability in proving lessees are using sustainable production practices;
allowing financial institutions to facilitate a mechanism that assesses the sustainability impact of farm clients as part of risk assessment and carbon pricing in loans;
providing carbon aggregators with data outputs that can be used for carbon credit generation and trading; and
allowing general value chain to estimate the scope 1-3 emissions of organizations as well as agribusinesses and others buying or selling from farmers; for example, the scope 3 emissions of their farm clients can be estimated.

Further, the disclosed systems, methods, and techniques can support the agriculture industry, food producers, and others in the food supply chain to:
(1) measure, monitor and report on environmental and sustainability impacts such as estimates of CO₂ consumption, contributions and capture of CO₂ and other greenhouse gas (GHG) resulting from their operations;
(2) support user awareness of (1) while supporting their ability to understand, develop strategy and operationalize plans to enhance operational efficiency, productivity and environmental sustainability (i.e. GHG, use of fertilizers, pesticides, herbicides, water and other inputs as well as emissions and other discharges resulting from the operations);
(3) develop and leverage technologies (via integrations) and innovations for “smart” agriculture to improve the user's capacity to collect, measure, monitor, analyze, understand, and communicate and report on user data relating to the foregoing in both manual and automated business processes; and
(4) enhancing user and industry capacity and capabilities to gather and understand (1) for analytical and statistical purposes to enable the user as well as, at a macro (i.e. aggregate) industry level, to make data driven decisions and monitor agricultural capabilities.

Accordingly, for farmers, the disclosed systems and methods can provide the ability to ingest, measure, monitor, and report on data relating to user operations relating to environmental sustainability (such as GHG (i.e. CO₂) capture and consumption) as well as operational efficiency, productivity and competitiveness in agriculture. Additionally, the disclosed systems and methods can support user awareness and utilization of available data relating to and including opportunities to improve operational efficiency, productivity, and the competitiveness of each user's operations, thus supporting the user to adopt, measure impact and improve upon best practices relating to sustainability and operational efficiency. Moreover, there could be an improvement in the user's ability to measure, challenge, monitor, and mitigate the financial impact of the governmental policy such as a carbon tax on their operations as well as related climate change and related sustainability policies which impact the industry (for example utilizing customer data to estimate an operation's capacity to capture as well as its direct and indirect consumption, contributions and emissions of CO₂ and other GHG in an uncomplicated way thereby enabling data driven decision-making for users to make improvements that enhance competitiveness, operational efficiency and sustainability including enabling accurate, simple and reliable reporting processes to access financial and governmental incentives).

For industry, the disclosed systems and methods can provide reliable, standardized measurement of data in understanding the industry's environmental impacts such as: carbon capture capacity, estimating or proving biodiversity related decisions and impacts, utilization of water, fertilizers, pesticides, fungicides and herbicides (including any components thereof), the consumption, emissions and contributions of the industry to CO₂ and other GHG targets, all of which can enable data driven decisions and analytics to demonstrate, report on and improve upon sustainability, efficiency, productivity and overall competitiveness.

For government, the disclosed systems and methods can improve capabilities to measure and understand individual (micro) and industry (macro, i.e. aggregated) data concerning environmental sustainability, improvements to productivity, efficiency and competitiveness and other trends including those which may result from responses to government policy (i.e. carbon taxation, financial incentives), climate change and the like; and empower capabilities to establish or improve upon the collection of statistical data, improve analytics and support data driven decisions to maintain or improve governmental policy to improve competitiveness of the industry, enhance sustainability, efficiency and the safety and stability of the farm and food industry.

Accordingly, the disclosed systems and methods can provide a comprehensive, accurate method for users to understand and improve their environmental impact in agricultural operations. By integrating, centralizing, standardizing, and optimizing data, it is possible to ensure that users can leverage their data effectively, regardless of the source. This holistic approach to evaluating sustainability metrics for a farm can support sustainable farm management practices, nature-based financing, and climate-smart agriculture, enhancing decision-making from a sustainability perspective. The systems and methods disclosed herein can offer a simple and consistent solution for sustainability analysis using the integration of upstream data sets as to enable downstream utilization of data outputs.

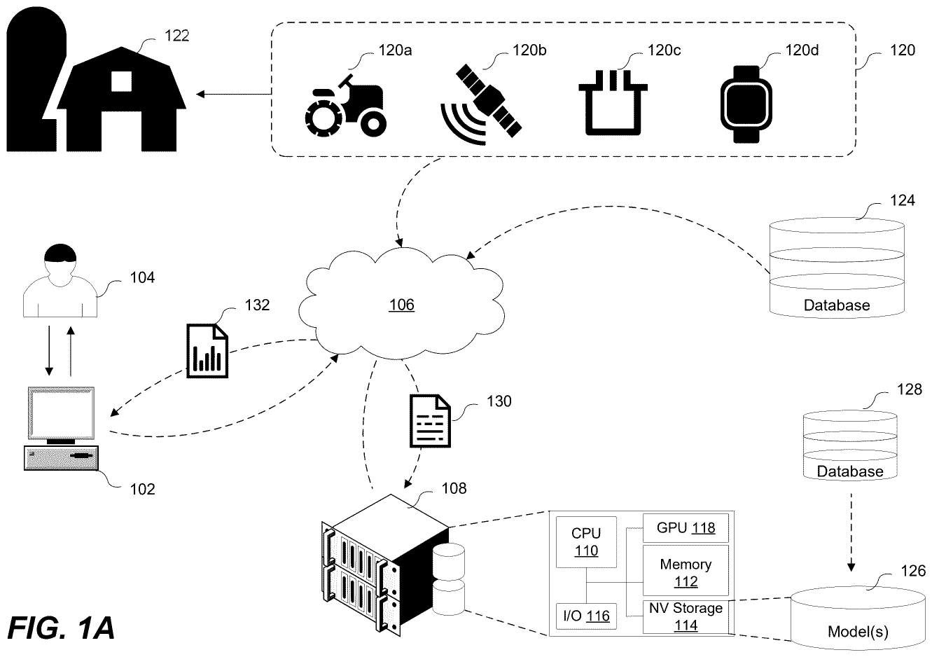

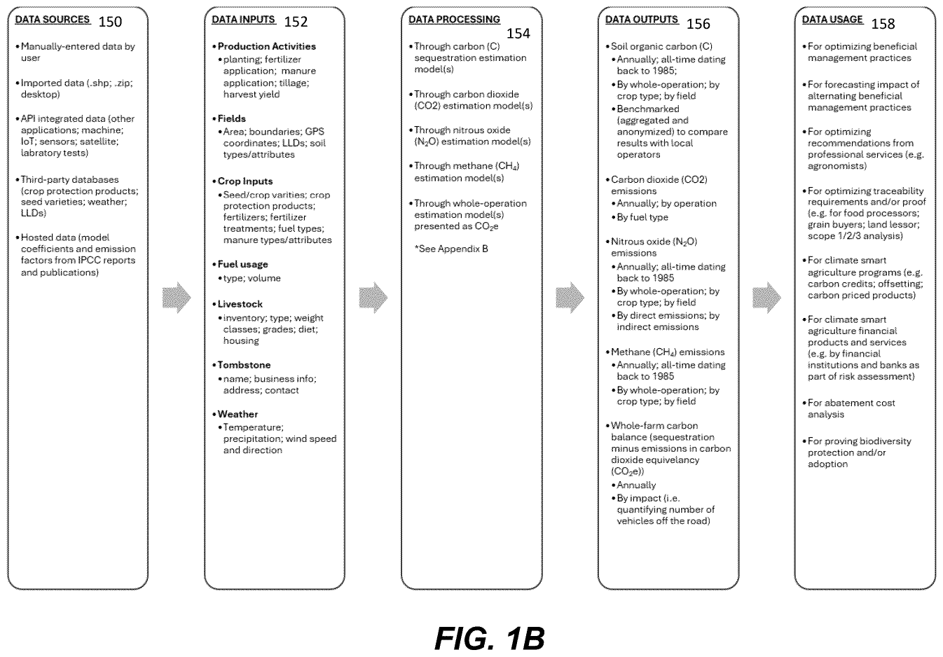

Embodiments are described below, by way of example only, with reference to FIGS. 1A-10O.

FIG. 1A depicts a system for evaluating a sustainability metric of a farm in accordance with the present disclosure. The system comprises one or more servers 108, which may for example be a physical server(s), cloud-based server(s), or a hybrid thereof. A user 104 may interact with the servers 108 via a user device 102 over a communications network 106 (e.g. the internet). The user device 102 may be a computer, as depicted in FIG. 1A, but is not restricted to those expressly shown and may be any suitable user computing device such as a smart phone, tablet, etc. The servers 108 may provide a website and/or web-based platform that is accessible by the user device 102 over the network 106, and may display a graphical user interface (GUI) on the user device 102. The implementation of the GUI is not restrictive and may be, for example, a mobile/computer application or a webpage. The GUI can be used to provide input to and receive output from the servers 108. In accordance with the present disclosure, a user 104 of user device 102 may be interested in performing a sustainability analysis on a farm 122. The farm 122 may comprise one or more crop fields upon which one or more crops may be planted, one or more livestock of one or more variations, one or more farm equipment/vehicles, infrastructure to support the farm and operations thereof, etc. As described in more detail herein below, the servers 108 are configured to perform a sustainability analysis for the farm, including the calculation of one or more sustainability metrics, such as a carbon sequestration, a N₂O emission, a CO₂ emission, and/or a CH₄ emission of the farm. The servers 108 may be configured to calculate a carbon balance for the farm based on the carbon sequestration, the N₂O emission, the CO₂ emission, and the CH₄ emission. The calculated sustainability metric(s) may be summarized as output 132 for display on the user device 102.

As depicted in FIG. 1A, the server(s) 108 each comprise a processing unit (CPU 110), a non-transitory computer-readable memory 112, a non-volatile storage 114, an input/output interface 116, and graphical processing units (“GPU”) 118. The non-transitory computer-readable memory 112 comprises computer-executable instructions stored thereon at runtime which, when executed by the CPU 110, configure the server(s) 108 to perform a method for evaluating a sustainability metric of a farm. The non-volatile storage 114 has stored on it computer-executable instructions that are loaded into the non-transitory computer-readable memory 112 at runtime. The input/output interface 116 allows the server to communicate with one or more devices such as the user device 102, external devices 120, and third party databases 124 (e.g. via network 106). In some aspects, the non-volatile storage 114 may have stored thereon one or more sustainability calculation models 126. Additionally or alternatively, the calculation models 126 may be stored at one or more separate servers or databases, and be accessed by the servers 108 via the I/O interface 116. The GPU 118 may be used to control a display and may also be used for implementing aspects of the method. The CPU 110 and GPU 118 may be one or more processors or microprocessors, which are examples of suitable processing units, which may additional or alternatively comprise an artificial intelligence accelerator, programmable logic controller, a microcontroller (which comprises both a processing unit and a non-transitory computer readable medium), neural processing unit (NPU), or system-on-a-chip (SoC). As an alternative to an implementation that relies on processor-executed computer program code, a hardware-based implementation may be used. For example, an application-specific integrated circuit (ASIC), field programmable gate array (FPGA), or other suitable type of hardware implementation may be used as an alternative to or to supplement an implementation that relies primarily on a processor executing computer program code stored on a computer medium.

One or more data inputs 130 associated with the farm 122 are provided to and/or obtained/retrieved by the servers 108 for performing the sustainability metric calculations. In accordance with the present disclosure, the servers 108 are configured to receive data from a variety of data sources for performing such sustainability metric calculations. There are three main data inputs contemplated: first data inputs received from the user device 102, which may include data that is manually entered by the user 104 and/or imported into the platform by the user 104; second data inputs obtained from one or more external devices 120 associated with the farm 120, by interacting with their application programming interfaces (APIs); and third data inputs obtained from a third party data source, such as database tables from one or more databases 124 managed by third party sources. For obtaining the second data inputs, the system may provide connectivity to certain equipment providers and/or third party platforms, such as John Deere™ FieldView™, etc., allowing users to connect to their existing accounts and directly import field operation data such as activities, fields, and inputs. Data from equipment providers and/or third party platforms may collect operational data from their farm equipment and provide a calculated summary of the operational data as the second data inputs. For obtaining the third data inputs, the system may have partnerships with third party data sources to provide automatic imports of data such as crop protection products, seeds and varieties, local weather, legal land descriptions, etc.

The second and third data inputs may be automatically obtained. In some cases, the second and third data inputs may be obtained in response to a user wishing to calculate a sustainability metric for their farm. In other instances, the second and third data inputs may be obtained at pre-determined times. For example, an automated process may be run weekly to pull a list of crop protection products and/or seeds and varieties. As another example, local weather may be automatically retrieved on the creation and update to activities based on date, time, and location. As yet another example, legal land descriptions (LLDs) can be automatically retrieved on the creation and update to field location and boundaries.

The external devices 120 may comprise a number of devices communicatively coupled to the servers 108 or to a platform accessible by the servers 108 that are configured to capture data associated with the farm and provide second data inputs corresponding to various agriculture factors or considerations that can affect the sustainability and environmental impact of the farm 122. The external devices 120 may for example comprise farm equipment, a vehicle, a satellite, a sensor, an Internet of Things (IoT) device, a third party computing device, etc. For example, one or more farm equipment 120a may support an API which captures data corresponding to or comprising at least the fuel type and fuel volume consumed by the farm equipment 120a while operating on the farm 122, as well as tillage and harvest yield, which can be provided to the servers 108 as input parameters 130. As another example, one or more satellites 120b may be configured to capture farm data corresponding to or comprising at least field area, field boundaries, and GPS data, which can be provided to the servers 108 as input parameters 130. As another example, one or more sensors or laboratory tests 120c can capture/determine data corresponding to or comprising at least soil data, which can be provided to the servers 108 as input parameters 130. As another example, one or more Internet of Things (IoT) devices 120d can capture farm data corresponding to or comprising at least livestock inventory, livestock type, livestock weight classes, livestock grades, livestock diet, and livestock housing data, which can be provided to the servers 108 as input parameters 130. The servers 108 may receive input parameters 130 directly from the external devices 120, or the data from the external devices may be obtained indirectly through an intermediary third party computing device/platform that collects the data from certain external devices.

It will thus be appreciated that a vast amount of data associated with the farm 122 can be collected by the system depicted in FIG. 1A for use in calculating one or more sustainability metrics of the farm 122. The input parameters 130 can comprise data relating to: production activities information such as planting method, fertilizer application, manure application; tillage; and harvest yield; crop field information such as field area, field boundaries, GPS data pertaining to the field, legal land descriptions, and soil data; planted crop information such as seed/crop varieties, crop protection products information, fertilizer data, fertilizer treatment data, fuel types, and manure type/attribute data; fuel information such as fuel type and fuel volume; livestock information such as livestock inventory, livestock type, livestock weight classes, livestock grades, livestock diet, and livestock housing data; weather information such as temperature data, precipitation data, wind speed data, and wind direction data; and other information such as entity name, business information, address, and contact information. Different sustainability calculation models will require different inputs for use in calculating a sustainability metric. For example, the following data listed in Tables 1 and 2 may be useful as inputs for calculating different sustainability metrics.

TABLE 1
Parameters retrieved automatically

| C sequestration | N2O emissions | CH4 emissions | CO2 emissions |
|---|---|---|---|
| Historic daily weather data | Annual growing season | Baseline | Conversion |
| | precipitation (May- | maintenance | factors/emission |
| | October), in ecodistrict | coefficient | factors |
| Soil data | Growing season | Average daily | |
| | potential | temperature | |
| | evapotranspiration, by | | |
| | ecodistrict | | |
| Start year of field history | Fraction of land | Feeding | |
| | occupied by lower | activity | |
| | portions of landscape | coefficient | |
| End year | Weighted modifier | Gain | |
| | based on texture-fine, | coefficient | |
| | medium and coarse | | |
| Yield (dry weight) | N source-synthetic, | Percent total | |
| | organic, crop residues | digestible | |
| | 1. Canadian Prairies and | nutrients in | |
| | the Montane Cordillera | feed | |
| | ecozone | | |
| | Conservation tillage | | |
| | Conventional tillage | | |
| | 2. Eastern Canada and | | |
| | the Pacific Maritime | | |
| | ecozone | | |
| | Conservation tillage | | |
| | Conventional tillage | | |
| Moisture content of crop | Cropping system | Milk | |
| | perennial | production | |
| | annual | | |
| Crop intercept values | Manure | Fat content | |
| | Moisture content (%) | | |
| Crop slope values | Manure | Pregnancy | |
| | N content (%) | coefficient | |
| Harvest index | Crop intercept values | Methane | |
| | | conversion | |
| | | factor | |
| Tillage factor | Crop slope values | Energy content | |
| | | of CH₄ | |
| Water factor | Harvest index | Conversion | |
| | | factor from | |
| | | weight to dry | |
| | | matter intake | |
| Sand % | Tillage factor | Conversion | |
| | | factor from | |
| | | volume to mass | |
| Harvest index | Water factor | Urinary energy | |
| Lignin content | Sand % | Ash content of | |
| | | feed | |
| Nitrogen content | Harvest index | Conversion | |
| | | factor for gross | |
| | | energy per kg | |
| | | of DM | |
| Beta value | Lignin content | Methane | |
| | | producing | |
| | | capacity | |
| Alpha value | Nitrogen content | | |
| Active decay rate | Beta | | |
| Slow decay rate | Alpha | Feed | |
| Passive decay rate | Active decay rate | Ingredients- | |
| Carbon coefficient of product | Slow decay rate | 846 ingredients | |
| Carbon coefficient of straw | Passive decay rate | Alfalfa cubes | |
| Carbon coefficient of roots | Nitrogen content in | Alfalfa dehy | |
| | product | Alfalfa fresh | |
| Carbon coefficient of extra-roots | Nitrogen content in | Alfalfa | |
| | straw | greenchop | |
| Percentage of product returned | Nitrogen content in | Alfalfa hay | |
| to soil | roots | Alfalfa haylage | |
| Percentage of straw returned to | Nitrogen content in | Almond hulls | |
| soil Moisture content of crop | extra-roots | Apple pomace | |
| Percentage of roots returned to | Fraction of N in | Bakery products | |
| soil | manure | Barley grain | |
| | Emission factor for | Barley grain | |
| | leaching | flaked . . . etc. | |
| | Volatilization emission | | |
| | factor | | |
| | N deposition amount | | |

TABLE 2
Parameters obtained from users

| | | CH4 | CO2 |
|---|---|---|---|
| C sequestration | N2O emissions | emissions | emissions |
| Farm location | Farm location | Animal | Fuel |
| | | type-beef, | type |
| | | dairy, | |
| | | swine, | |
| | | poultry, | |
| | | sheep, | |
| | | other | |
| | | livestock | |
| Field Name | Field Name | No of | Fuel |
| | | each | volume |
| | | animal | |
| | | type | |
| Total area of the | Total area of the field | Start date | |
| field | | of the | |
| | | manage- | |
| | | ment period | |
| Cropping Year | Cropping Year | End date | |
| | | of the | |
| | | manage- | |
| | | ment period | |
| Main crop | Main crop | Initial | |
| | | weight | |
| | | (weight | |
| | | at the | |
| | | beginning | |
| | | of the | |
| | | manage- | |
| | | ment | |
| | | period) | |
| Winter/Cover/ | Winter/Cover/ | Final | |
| Undersown Crop | Undersown Crop | weight | |
| | | (weight | |
| | | at the | |
| | | end of | |
| | | the | |
| | | manage- | |
| | | ment | |
| | | period) | |
| Crop yield (wet | Crop yield (wet yield) | Diet type | |
| yield) | | | |
| Tillage-no tillage, | Tillage-no tillage, | Diet | |
| reduced, | reduced, intensive | additives | |
| intensive | | None | |
| | | 2% fat | |
| | | 4% fat | |
| | | Ionophore | |
| | | Ionophore + | |
| | | 2% fat | |
| | | Ionophore + | |
| | | 4% fat | |
| Harvest method- | Harvest method-cash | Housing | |
| cash crop, | crop, swathing | types | |
| swathing | | Confined | |
| | | no- | |
| | | barn | |
| | | (feedlot) | |
| | | House in | |
| | | barn | |
| | | Pasture | |
| Manure type | N source | Manure | |
| | Inorganic fertilizers | type | |
| | Enhanced efficiency | | |
| | fertilizers | | |
| Origin of manure | N % content in the | Origin of | |
| | fertilizer | manure | |
| Manure handling | Fertilizer application | Manure | |
| system | rate | handling | |
| | | system | |
| Application | Fertilizer application | Application | |
| method | methods | method | |
| Manure | Enhanced efficiency | Manure | |
| | fertilizer types- | | |
| | 1. Controlled Release | application | |
| | 2. Nitrification Inhibitor | rate | |
| application rate | 3. Urease Inhibitor | | |
| | 4. Nitrification And | | |
| | Urease | | |
| | Inhibitor | | |
| | Manure type | Amount of | |
| | | C from | |
| | | applied | |
| | | manure | |
| | Origin of manure | | |
| | Manure handling system | | |
| | Application method | | |
| | Manure application rate | | |
| | Amount of N from | | |
| | applied manure | | |

The servers 108 are configured to process the input parameters 130 comprising first, second, and third data inputs described above for sustainability analysis. The servers 108 can integrate the data comprising input parameters 130 and standardize the received data, as described further below. The servers 108 can also sort the data, homogenize, and filter the data. In particular, the data can be processed to extract a number of parameters for use in sustainability analysis calculations. The servers 108 are configured to calculate one or more sustainability metrics using one or more sustainability calculation models. The calculation models 126 are able to calculate a sustainability metric based on the various data inputs 130. For example, the calculation models 126 may comprise a carbon sequestration model configured to calculate the amount of carbon captured by the farm 122, a N₂O emission model configured to calculate the amount of N₂O emitted by the farm 122 and operations thereof, a CO₂ emission model configured to calculate the amount of CO₂ emitted by the farm 122 and operations thereof, and a CH₄ emission model configured to calculate the amount of CH₄ emitted by the farm 122 and operations thereof. The sustainability parameters/values determined by the calculation models 126 may be processed by the servers 108 to estimate the overall farm sustainability and to generate various outputs 132 for display to the user. The calculation models 126 may be imported or retrieved from one or more databases 128. The servers 108 may also query the databases 128 to update the calculation models 126 at regular intervals or as a response to the user 102 or device interacting with the servers 108. Each of the calculation models may be imported from the same or different databases. Further, a plurality of calculation models performing the same or similar functions in sustainability calculation/estimations may be imported. Accordingly, it will be appreciated that the system can quickly and easily adopt different sustainability calculation models.

FIG. 1B shows a data flow diagram using the system. As shown in FIG. 1B, data inputs are received (150), which may comprise manually-entered data by a user, imported data (e.g., .shp; .zip; desktop files), API integrated data, third-party database data, and/or hosted data (e.g. model coefficients and emissions factors from IPCC reports and publications). The data sources are filtered and standardized, as described in more detail below, and provided as data inputs (152), which may comprise production activity data, field data, crop input data, fuel usage data, livestock data, tombstone data (e.g. name, business info., address, contact information, etc.), weather data, etc. The data inputs are processed (154) using one or more sustainability calculation models (e.g. a carbon sequestration estimation model, a carbon dioxide estimation model, a nitrous oxide estimation model, a methane estimation model, and/or a whole-operation estimation model) to calculate one or more sustainability calculation metrics and any associated output data, which are provided as data outputs (156). The data outputs can be used in various downstream applications (158), as described above.

Referring back to FIG. 1A, a user 104 can indicate a particular sustainability metric for the servers 108 to evaluate, for example, by specifying the calculations to be performed by the calculation models 126. The servers 108 can present the data inputs required to be input by the user. The servers 108 may prompt the user 102 to provide the required data inputs 130 corresponding to the user's indication. The servers 108 can also automatically retrieve data inputs 130 from the external devices 120 and the third party databases 124, for example, at regular intervals or in response to an indication of the user 104 on the device 102. In some embodiments, the servers 108 may first retrieve input parameters 130 that are required from the external devices 120 and the third party databases 124, if available. The user 102 may then provide to the servers 108 with required input parameters 130 that are not available through retrieval from the external devices 120 and the third party databases 124. In some embodiments, the user 102 may provide known input parameters 130 (e.g. required parameters that are known or all known parameters) to the servers 108 in which case the servers 108 may retrieve missing parameters from the external devices 120 and the third party databases 124 or provide estimations thereof. The calculation parameters may be extracted from the input parameters 130 based on the input required for the calculation models 126, for example, so that only relevant information or data required for the calculations may be extracted. The input parameters 130 may also be processed by the servers 108 to extract the calculation parameters by converting the data into a form or format accepted by the calculation models 126. For example, the input parameters 130 may be converted to numerical values or image data for processing by the calculation models 126. The servers 108 may be configured to store the input parameters 130, the calculated sustainability metrics, and the sustainability assessment output 132, in an associated database. The servers 108 may be used to perform calculations for a plurality of farms, and may store calculated sustainability metrics for all farms, which can be used for comparison and benchmarking, as described in more detail below.

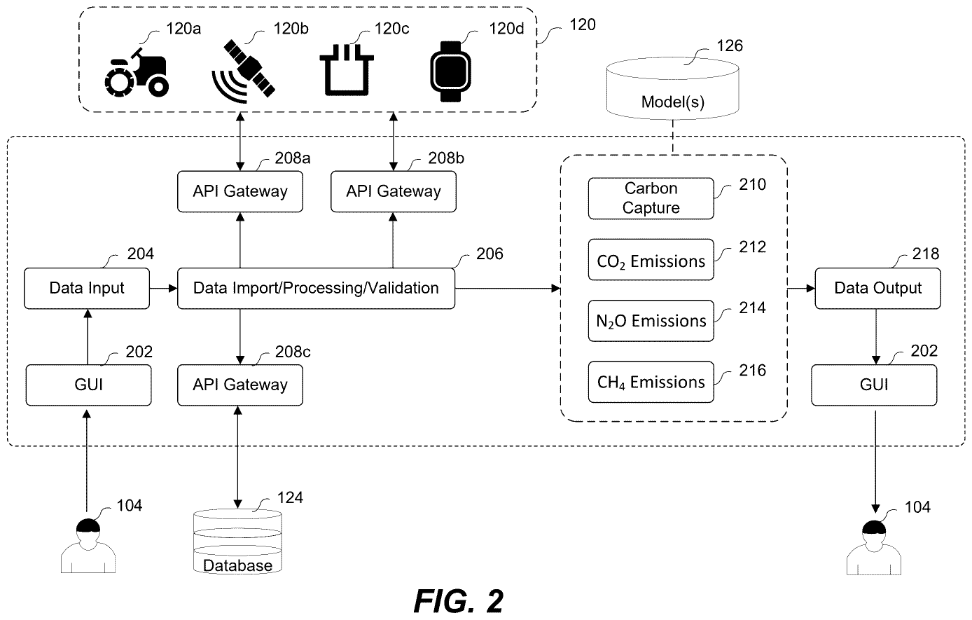

FIG. 2 shows a representation of an architecture of the system. As shown in FIG. 2, a user 104 can interact with a GUI 202 presented on a user device, to enter/import data as represented by data input 204, which can be passed to a data import/processing/validation module 206. Further, input data may be received at the data import/processing/validation module 206 from one or more API gateways. For example, input data may be received from one or more external devices 120 associated with the farm through API gateways 208a and 208b, and/or data from one or more third party databases may be received through API gateway 208c. External data sources must have a secure API that the system connects to. A secure connection may either be established by customers credentials using OAuth and/or a secret key unique to the system. External APIs can be accessible via Internet technologies.

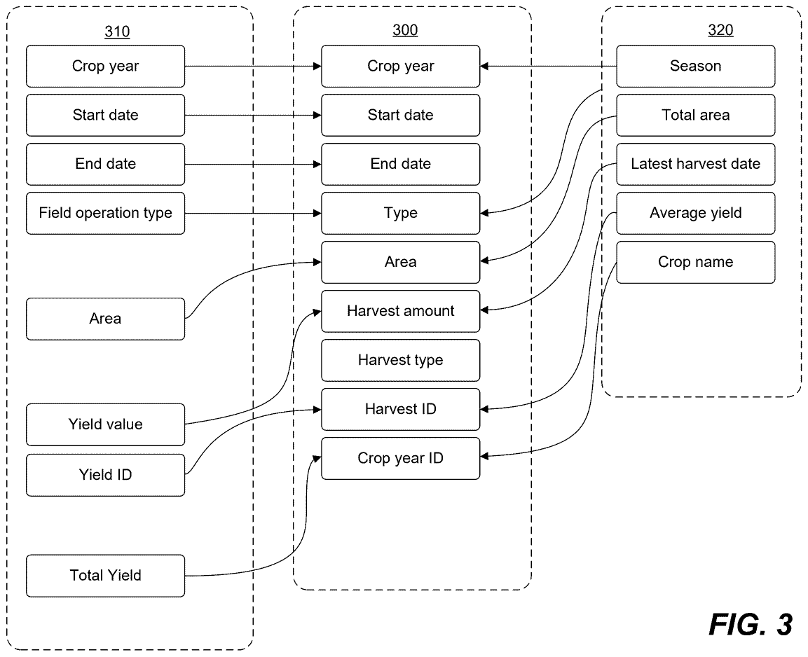

The data import/processing/validation module 206 is configured to prepare the data for input to the sustainability calculation model(s). For example, FIG. 3 shows a representation of standardizing data inputs. In FIG. 3, data inputs 310 and 320, which are obtained from two different data sources and correspond to data obtained from farm equipment and data obtained from an external farming software platform respectively, are matched to data fields used by the sustainability platform 300, which can then be used for performing a sustainability metric calculation using a sustainability calculation model. As seen in FIG. 3, data from different data sources may have different data fields that need to be standardized by matching to the appropriate data field of the sustainability platform 300. In some instances, data inputs also need to be converted and/or normalized, e.g. to ensure that units are correct.

Referring back to FIG. 2, some further examples of the functionality performed by the data import/processing/validation module 206 may include boundary conversion and/or unit conversion/normalization. For boundary conversion, boundaries are normally provided as latitude and longitude coordinates, and are typically in the shape of multi-polygons, polygons, lines, and points. These can be in any form a third-party chooses but must be valid coordinates and produce an accurate representation. This format is converted to a format usable for the sustainability calculation model, which may require the GeoJSON standard. For unit conversion/normalization, supported units may be of type area, volume, or weight. The module supports the conversion of many of these data types such as: litres to gallons, pounds to kilograms, and acres to hectares.

After the data has been processed by the data import/processing/validation module 206, it can be provided to one or more sustainability calculation models for calculating a sustainability metric. As described above, different sustainability calculation models may be run, such as a carbon capture/carbon sequestration model 210, a CO₂ emissions model 212, a N₂O emissions model 214, and/or a CH₄ emissions model 216. As one non-limiting example, the Holos™ model, developed by Agriculture and Agri-Food Canada, may be used to provide estimates of greenhouse gas (GHG) emissions and changes in soil carbon (C). However, as also described above, the systems and methods disclosed herein are not limited to any particular model. The following mathematical equations are examples of how different sustainability metrics (i.e. C sequestration, nitrous oxide emissions, carbon dioxide emissions, methane emissions, and a whole-farm carbon balance) may be calculated in the different models.

### 1. C Sequestration

The International Panel on Climate Change (IPCC) Tier 2 Carbon (C) model is a three sub-pool steady-state C model that provides an optional alternative method for estimating soil C stock changes in the 0-30 cm layer of mineral soils in croplands. The abbreviation SOC stands for soil organic carbon, and the SOC stock is a combination of the active subpool SOC stock, the slow subpool SOC stock, and the passive subpool SOC stock.

$$SOC stock = Active subpool SOC stock + Slow subpool SOC stock + Passive subpool SOC stock$$

$$\begin{matrix}2. {N}_{2} O emissions & \\ \begin{matrix}{N}_{2} O emissions = ( {N}_{2} {O}_{inorganic fertilizers} + {N}_{2} {O}_{Crop residues} \\ + {N}_{2} {O}_{mineralization of crop residues} \\ + {N}_{2} {O}_{organic ammendments} + {N}_{2} {O}_{fertilizer leaching} \\ + {N}_{2} {O}_{crop residue leaching} + {N}_{2} {O}_{mieralized N leaching} \\ + {N}_{2} {O}_{organic ammendments leaching} \\ + {N}_{2} {O}_{inorganic fertilizer vocatilization} \\ + {N}_{2} {O}_{Organic ammendments volatilization} )\end{matrix} & \end{matrix}$$

$$\begin{matrix}3. {CO2}_{2} emissions & \\ \begin{matrix}CO2 emissions = ( Fuel {volume}_{diesel} * Conversion {factor}_{diesel} ) \\ + ( Fuel {volume}_{propane} * Conversion {factor}_{propane} ) \\ + ( Fuel {volume}_{gasoline} * Conversion {factor}_{gasoline} ) \\ + ( Fuel {volume}_{natural gas} * Conversion {factor}_{natural gas} )\end{matrix} & \end{matrix}$$

$$\begin{matrix}4. CH {4}_{4} emissions & \\ CH 4 emissions = ( CH 4 {emissions}_{enteric fermentation} + CH 4 {emissions}_{Manure} ) & \end{matrix}$$

$$5. C balance$$

$$\begin{matrix}Whole farm C balance = C sequestration - ( N2O emissions + CO2 emissions \\ + CH4 emissions )\end{matrix}$$

The one or more sustainability calculation models provide data output 218 that includes the calculated sustainability metric(s) for the farm. The data output 218 may be further analyzed/processed to generate various insights for the user. For example: trend analysis may provide long term and year-over-year trends to identity whether a farm is sequestering or emitting; benchmark values may be provided so that the user will be able to compare output with similar operations; output per field and output per crop may be provided so that users can understand which fields or crops have higher emissions or lower sequestration, so that the user will be able to improve management practices in those areas; Nitrogen insights may be provided to help the user to understand how well nitrogen is being utilized by plants and how it impacts on emissions and sequestration; scenario analysis may be provided to add a ‘what if’ scenario feature where a user can explore the impact of different management practices before implementing them in the field.

The data output 218, which may comprise the sustainability metric calculated by the model, along with any other insights generated, can then be displayed in the GUI 202 for the user 104.

Various flow diagrams representing how the system operates to evaluate a sustainability metric for a farm are now described.

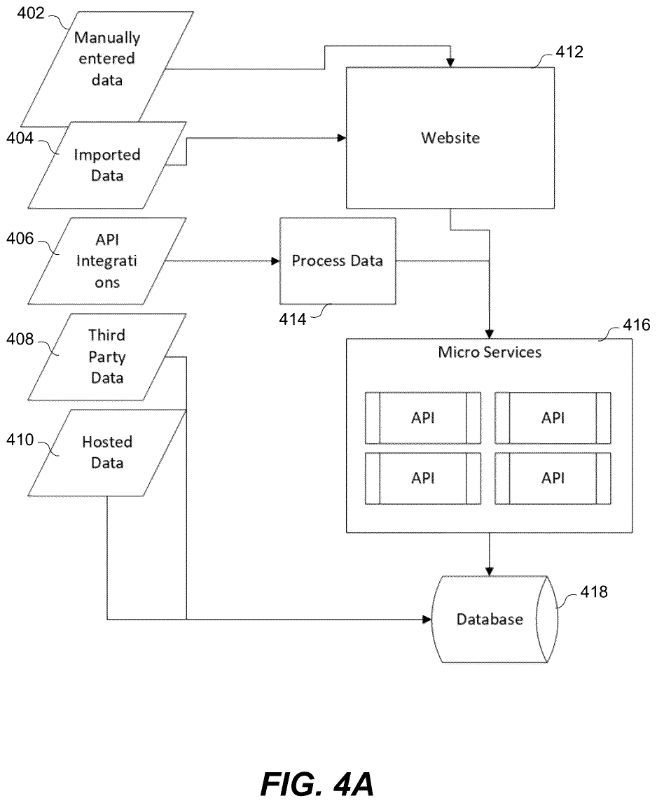

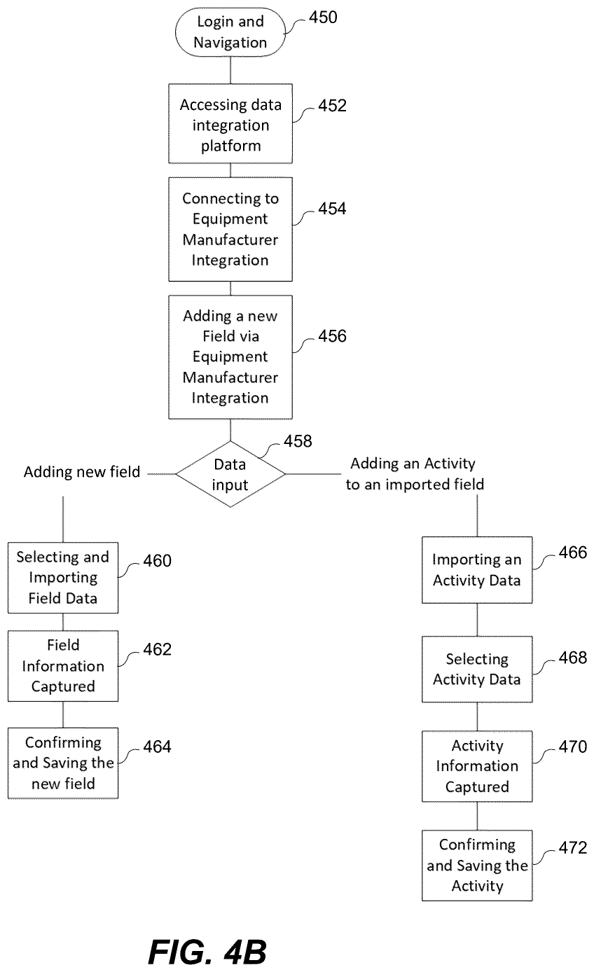

FIG. 4A shows a flow diagram of how data is collected, processed, and stored for evaluating a sustainability metric of a farm. As seen in FIG. 4A, various types of data inputs are collected, including manually entered data 402, imported data 404, data from API integrations 406, third party data 408, and hosted data 410.

Manually entered data 402 and imported data 404 may be provided via a website 412 (or a web application, mobile application, etc.). Manually entered data 402 can be manually input by users using web forms. Built-in data validation may be implemented to ensure proper formatting and expected data types. Imported data 404 may be files that can be imported into the system, such as .shp, .zip, and .csv files. There may be specific formatting requirements for these file types to ensure successful uploads.

Data from API integrations 406 may be information that is obtained from an external device belonging to third-party partners, and that flows between the system APIs and third-party APIs. After authentication, the system interacts with their APIs to import or export data. A normalization or transformation process performs processing of the data (414) to ensure that this third-party data conforms to the system's schema, and data validation may also occur during this step.

Data obtained via the website 412 and processed data obtained at 414 interacts with microservices 416, which contain various APIs. These APIs then interact with a database 418 to facilitate information flow in and out.

Third-party data 408 is data that usually comes directly from third-party sources in the form of database tables. Examples of third-party data may include verified lists of crop protection products and seeds from vendors, providing a standardized list for users. Third-party data 408 is generally obtained via secure methods and manually entered into the database 418.

Hosted data 410 includes other types of data, primarily hardcoded data like unit conversions or model calculations, which is hosted within the system. Hosted data 410 is primarily entered into the database 418 or stored in a codebase.

FIG. 4B shows a flow diagram providing an example of how a user inputs data to the system. In particular, the flow diagram represents a user journey example of how an existing user may access a platform provided by the system to import their machine data, and how the system ensures that the machine data is correct. A user can input and track this data over time, so that the data can be saved and accessed for performing a sustainability metric calculation as described herein. It will be appreciated that there are many examples of how users use manually-entered, imported, and/or automatically collected data in order to estimate sustainability measurements. The example represented by the flow diagram in FIG. 4B is for an existing user with fields and boundaries already set up but wants to add more, and importing updated production information from their machinery in order to get their carbon sequestration estimates.

The flow diagram shows that a user logs into an application provided by the system (450). The system may provide a dashboard for display, for example showing an overview of the user's farm data.

The user navigates to an application integration platform (452). The system may display different machine data, OEMs or technology providers. A list of existing fields for the user may also be displayed, with an option to add a new field.

The user logs into their Equipment Manufacturer account and grants permission for data access (454). The system retrieves available field data from the Equipment Manufacturer account. A new field may be added via an Equipment Manufacturer account by the user selecting the option to add a new field and choosing the appropriate integration (456). The system may prompt the user to securely authenticate and connect their Equipment Manufacturer account.

A determination is made regarding the type of data that the user wishes to input (458). For example, the user may choose to add a new field for data capture, or they may choose to add an activity to an existing field. The user can either add new, combine with existing, or ignore fields altogether. The user selects the field(s) they want to import from the Equipment Manufacturer data (460). The system imports the selected field data and may display a summary for confirmation. Field information is captured (462), which may for example include a Field Name (i.e. the name of the field), the Field Location (e.g. GPS coordinates and/or address or Legal Land Description), Field Size (e.g. an area of the field in acres or hectares), and Field Boundaries (e.g. geospatial data outlining the field's boundaries). The user reviews the imported field data and confirms the addition (464), and the new field is added in the system to the user's field list.

When the user wishes to add activity data to an imported field (e.g. an existing field or a newly imported field), they may be prompted to import a list of activities that were applied to the fields that have been added (466). For example, the system may prompt the user to choose an activity data (e.g. planting, spraying) associated with the field. The user can select the specific activity they want to import (468), and the system retrieves and displays the activity data for review. Activity information is captured (470), such as:
Activity Type: Type of activity (e.g., planting, spraying);
Status: Planned or Completed;
Date: When the activity was performed;
Equipment Used: Details of the equipment used for the activity;
Inputs Applied: Information about seeds, fertilizers, pesticides, etc.;
Field Affected: The field(s) where the activity took place;
Operator: The person who performed the activity; and
Notes: Any additional notes or observations.

The user reviews the imported activity data and confirms the imported data (472). The activity is added to the user's activity log, and can be used to calculate a sustainability metric as disclosed herein. The data may be stored on a per year basis, so that every single year the data is tracked.

As described herein, the input data is normalized to ensure all data is formatted in the same/correct units, and standardized to map input data types to the same/correct data types used in the one or more sustainability calculation models. Further, the data may be cleaned to remove irrelevant data, and processed to identify any issues in the data and/or filter the data. For example, the field information captured at 462 and the activity information captured at 470 may undergo data cleaning/processing/normalization/standardization. In particular, the following may be performed:

Reviewing data issues: the system identifies any missing information, inconsistences an errors or incomplete data. When such gaps are detected, the system can notify the user with an error message highlighting the incomplete data. E.g.—yield, fields, fertilizer and manure application rates and application methods.

Data filtering: As a part of data cleaning process, the system may apply specific filters. For example, annual C change values below −2 and above +2 t per acre may be excluded for benchmark analysis as they fall outside the acceptance range. As another example, C sequestration values between 5 and 60 ton per ha may be retained for benchmark analysis and values outside this range is excluded.

Handling irrelevant data: when data is missing, incorrect or affected by external factors such as rent or selling, user has the option to hide or ignore fields. This will remove those fields from calculations and make sure they do not impact the analysis.

Unit/data conversions: the application allows users to input data in a farmer friendly unit, and performs the conversions to ensure compatibility with the model. The output may likewise be converted for display a user-friendly/preferred units. Also, the system simplifies data entry which are easy to understand by users. For example, C and N content in manure may be collected as % and the back-end converts them into fractions to ensure compatibility with the model.

Mapping user inputs to model requirements: the system allows user to best match their inputs and the system maps/organizes these diverse inputs into standardized formats required by the model. As an example, the system may allow a user to select from many N application methods that suit to their practice. Then these methods are grouped into corresponding methods in the relevant model. As another example, there may be data coming from a third-party indicating what they define as a ‘field’ is 1 field and it's 640 acres, which may be corrected to map and standardize it to be 4 fields at 160 acres each. Another simple example could be correcting the weather: when importing from equipment, the user in the cab of the machine may have entered the incorrect dates (2014 instead of 2024) for a plant activity. Because the modelling depends on what the weather was for specific dates, that has an impact on the outputs and accuracy. So the UI can ensure the user has the correct dates entered so they therefore have the correct weather data coming through. As still a further example, a third-party may define a single pass on a field as an entire ‘activity’, which is incorrect and can be standardized to ensure all of those micro passes are represented correctly as a single activity to not skew results or outputs.

It will be appreciated that there are countless examples of how data is imported (manually or automatically) and preprocessed prior to input into the sustainability calculation model(s) (e.g. through data cleaning, processing, normalization, and standardization), and therefore the above examples are not limiting.

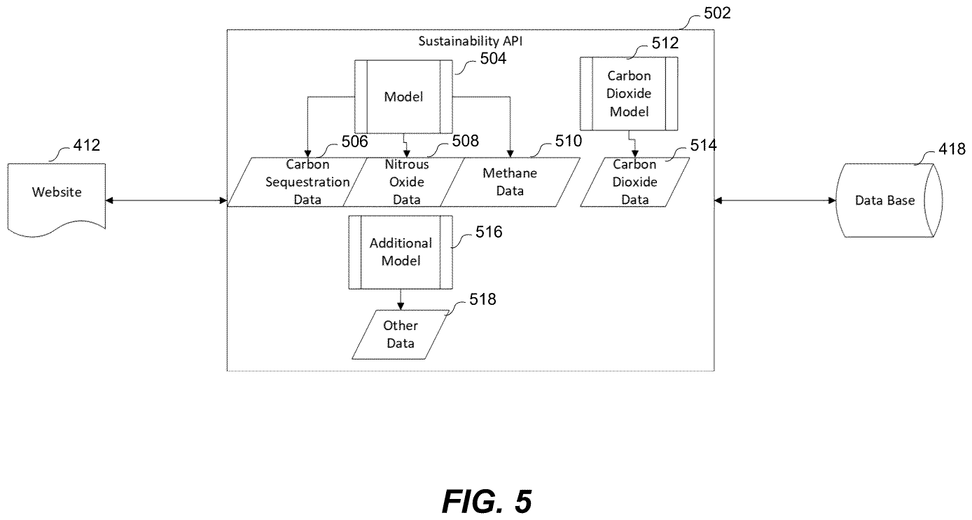

FIG. 5 shows a flow diagram of how different models are used for evaluating a sustainability metric of a farm. In FIG. 5, input data collected from the website 412 and input data that has been stored in the database 418 is passed to a sustainability API 502, which is configured to interact with both the website 412 and database 418 to retrieve and update data.

A sustainability API 502 hosts several models and is designed with flexibility in mind, allowing for future expansion to accommodate additional models based on customer needs and emerging sustainable practices. In the example shown in FIG. 5, a first model 504 may be used to calculate and output carbon sequestration data 506, nitrous oxide data 508, and/or methane data 510. However, it will also be appreciated that each of these datasets may be calculated using separate models. A separate carbon dioxide model 512 may be used to calculate and output carbon dioxide data 514. Additional model(s) 516 may be used to calculate and output other data 518.

Data that is generated from the calculations may be output to the website 412, and/or stored in the database 418.

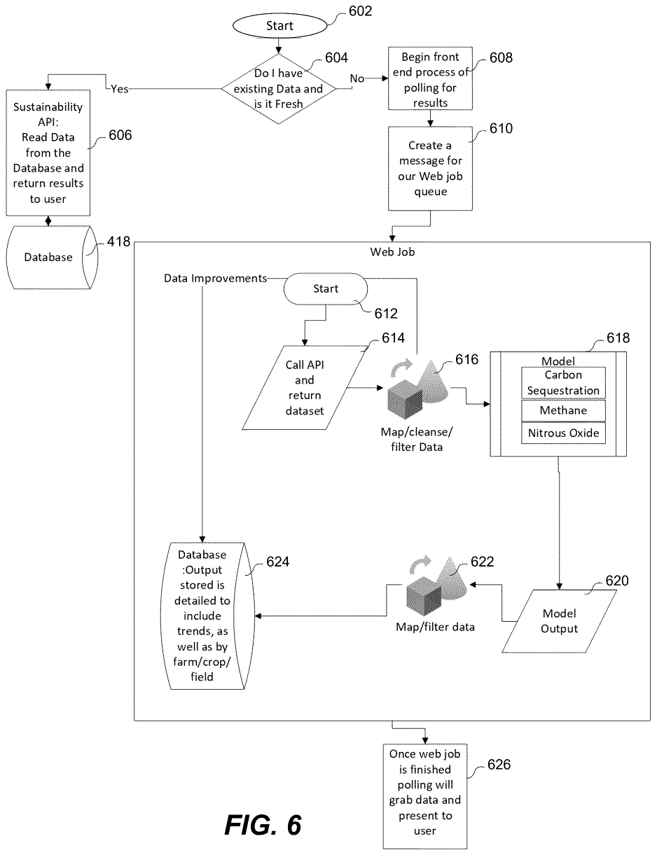

FIG. 6 shows a flow diagram for evaluating a sustainability metric of a farm. The flow diagram depicted in FIG. 6 may be performed after the user has captured data associated with the farm. The flow for evaluating the sustainability metric begins by a user navigating to an appropriate webpage (602). A check is performed to determine if the user has existing sustainability data and if so, whether the data is considered fresh (604). If the user has recently calculated one or more sustainability metrics within a predetermined threshold amount of time (YES at 604), the user's sustainability data stored in the database 418 can be presented to the user (606). If the user's sustainability data has not been calculated or is outdated (NO at 604), a web job is executed. The web job is a message queue that runs to perform the evaluation of one or more sustainability metrics. To run the web job, two processes are initiated. First, the front end starts polling for the information to be available from the database (608). Second, the user's farm is added to a message on the queue (610).

Once the queue item is selected in the web job, the evaluation of one or more sustainability metrics for the user's farm starts (612). First, all the necessary input data for the user's farm is collected/retrieved for the sustainability calculation model(s) that will run the calculations (614). The input dataset may be retrieved from the user data captured and stored as for example described with reference to FIG. 4B. Data mapping may be performed (616) by taking the retrieved input data and mapping it, for example, to the model data map (i.e. data standardization). During this data mapping process, data cleansing and any necessary unit conversions may also be performed. Further, any suggested improvements that can be made to the data can be determined (e.g. if there is missing information or if information appears incorrect), which may be presented to the user.

Once the data mapping is completed, the mapped input data is passed to the sustainability calculation model(s) to calculate one or more sustainability metrics (618). For example, the mapped input data may be passed to a model used to calculate carbon sequestration data, nitrous oxide data, and/or methane data. The model generates a model output comprising a dataset for the sustainability metric(s) (620).

The model output dataset may be mapped back to the schema supported by the website/preferred by the user (622). In addition, filtering may be performed to filter out any data anomalies and apply reasonability testing to the dataset. Once the data is mapped back to the desired schema, the sustainability metric data is stored in the database (624). The polling process initiated at the beginning can then serve the information to the user (626).

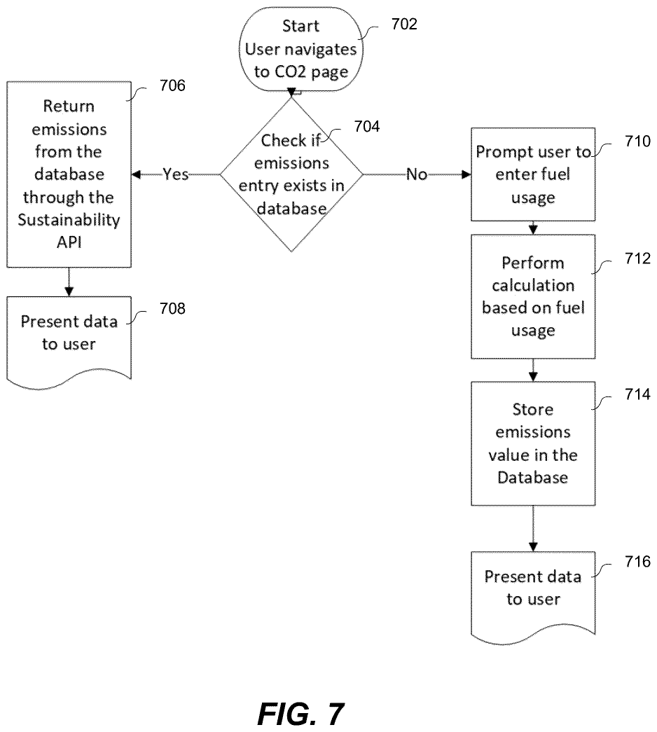

FIG. 7 shows a flow diagram for evaluating carbon dioxide emissions of a farm. The carbon dioxide emission evaluation process begins when a user navigates to an appropriate webpage (702). A check is performed to determine if the user has existing carbon dioxide emission data and if so, whether the data was calculated recently (704). If the user has recently calculated carbon dioxide emissions within a predetermined threshold amount of time (YES at 704), the user's carbon dioxide emissions data stored in the database 418 can be retrieved (706) and presented to the user (708). If the user's carbon dioxide emissions data has not been calculated or is outdated (NO at 704), the user is prompted to enter their total fuel consumption (710). The carbon dioxide emissions calculation based on this input of total fuel consumption is performed using a carbon dioxide emissions model (712) to generate an output. The output of the carbon dioxide emissions is stored in the database (714), and the results are presented to the user (716).

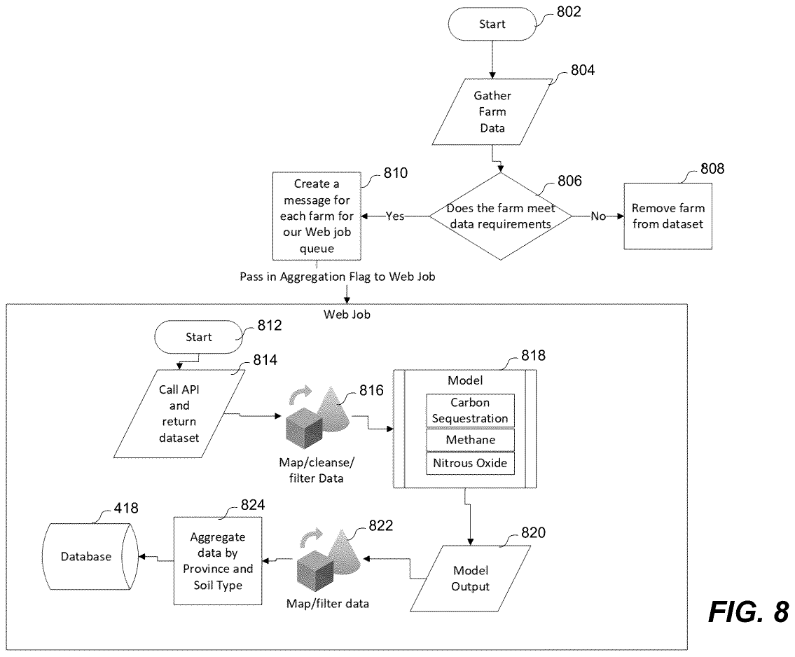

FIG. 8 shows a flow diagram for benchmarking a sustainability metric of a farm. In FIG. 8, a web job is created to run on a regular basis to create benchmarks for users. These benchmarks will allow users to compare their sustainability metrics (e.g. sequestration and emission numbers) against an average from similar farm operations to their own.

When the benchmarking process starts (802), data for all farms within the database is gathered (804) and a determination is made to check if farm data meets pre-defined data requirements for the benchmark calculation (806). For example, a pre-defined requirement for the benchmark calculation may be that there needs to be n number of years of sustainability metric data for a given farm. Farms that do not meet the data requirements (NO at 806) are removed from the dataset (808). Farms that meet the data requirements (YES at 806) are added to the benchmarking dataset. The process for calculating the benchmark is similar to the process for evaluating a sustainability metric of a respective farm, with one key difference: for benchmarking, a parameter is passed that informs the process to aggregate the data for benchmarking rather than store it individually per farm.

Each farm from the benchmarking dataset is added as a message on the queue and is picked up individually to run on the web job (810). Once the queue item is selected in the web job, the evaluation of one or more sustainability metrics for the respective farm starts (812). First, all the necessary input data for the respective farm is collected for the sustainability calculation model(s) that will run the calculations (814). Data mapping may be performed (816) by taking the retrieved input data and mapping it, for example, to the model data map (i.e. data standardization). During this data mapping process, data cleansing and any necessary unit conversions may also be performed. Further, any suggested improvements that can be made to the data can be determined, which may be presented to the user.

Once the data mapping is completed, the mapped input data is passed to the sustainability calculation model(s) to calculate one or more sustainability metrics (818). For example, the mapped input data may be passed to a model used to calculate carbon sequestration data, nitrous oxide data, and/or methane data. The model generates a model output comprising a dataset for the sustainability metric(s) (820). The model output dataset may be mapped back to the desired schema (822). In addition, filtering may be performed to filter out any data anomalies and apply reasonability testing to the dataset. Once the data is mapped back to the desired schema, the sustainability metric data is aggregated (e.g. province/state, soil type, etc.) and stored in the database (824).

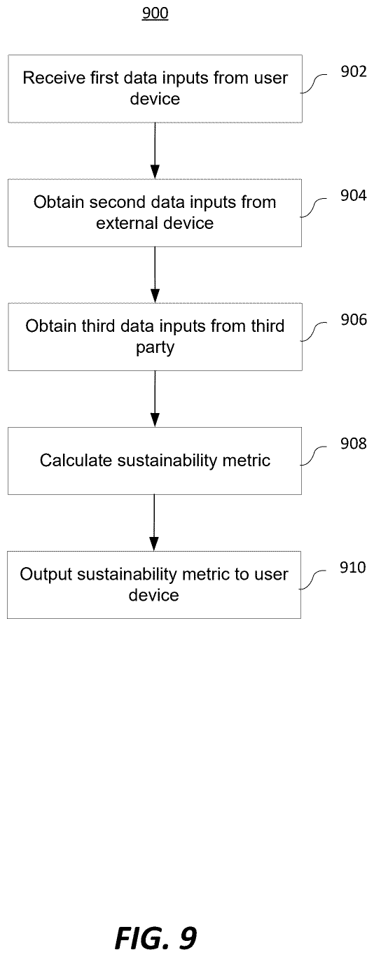

FIG. 9 shows a method 900 for evaluating a sustainability metric of a farm. The method 900 is a computer-implemented method that may be implemented by the system shown in FIG. 1, such as by the servers 108. Computer-executable instructions for implementing the method may be stored on a non-transitory computer-readable medium, which when executed by a processor, configure the processor to implement the method.

The method 900 comprises receiving, from a user device, one or more first data inputs associated with the farm (902). The one or more first data inputs may comprise manually entered data and/or imported data. In some examples, the one or more first data inputs may comprise: agriculture activity data, crop field data, crop data, livestock data, or combinations thereof.

The method 900 further comprises obtaining, from an external device via an application programming interface, one or more second data inputs associated with the farm (904). The external device may comprise: farm equipment, a vehicle, a satellite, a sensor, an IoT device, a third party computing device, or combinations thereof. In some examples, the one or more second data inputs may comprise: fuel data, weather data, soil data, or combinations thereof.

The method 900 further comprises obtaining, from a third party data source, one or more third data inputs associated with the farm (906). The third data inputs may be obtained from one or more third party databases. In some examples, the one or more third data inputs may comprise: crop product data, seed product data, legal land descriptions, or combinations thereof.

In some embodiments, the method 900 may comprise obtaining the second data inputs and the third data inputs automatically, such as at pre-determined intervals, and/or in response to a user request to calculate a sustainability metric.

Based on the one or more first data inputs, the one or more second data inputs, and the one or more third data inputs, the method 900 comprises calculating, using at least one sustainability calculation model, one or more sustainability metrics of the farm (908). The at least one sustainability calculation model may comprise: a carbon sequestration model, a N₂O emission model, a CO₂ emission model, a CH₄ emission model, or a combination thereof. The one or more sustainability metrics may be one or more of a carbon sequestration, a N₂O emission, a CO₂ emission, and a CH₄ emission of the farm. The method may further comprise calculating a carbon balance for the farm based on the carbon sequestration, the N₂O emission, the CO₂ emission, and the CH₄ emission.

The one or more sustainability metrics are output for display on the user device (910).

In some embodiments, prior to inputting the one or more first data input, the one or more second data inputs, and/or the one or more third data input for use in the at least one sustainability calculation model, the first, second, and/or third data inputs are standardized by mapping the input data to standardized data fields used by the model(s). Additionally, data normalization may be performed to ensure that all units are the same.

Additionally or alternatively, in some embodiments, prior to inputting the one or more first data input, the one or more second data inputs, and/or the one or more third data inputs for use in the at least one sustainability calculation model, the method may further comprise determining a suggested improvement that a user can make to the one or more first data inputs, and outputting the suggested improvement for display on the user device prior to calculating the one or more sustainability metrics. For example, determining the suggested improvement may comprise: identifying one or more missing values from the first data inputs; and prompting the user to input the one or more missing values. As another example, determining the suggested improvement may comprise: comparing the one or more first data inputs to pre-defined threshold values; and prompting the user to revise a value of the one or more first data inputs when the value is determined to be outside the pre-defined threshold values.

Various insights may also be generated as part of the method 900. In some embodiments, the method 900 may further comprise: storing the one or more sustainability metrics in a database; generating trend data of the one or more sustainably metrics for the farm over time; and outputting the trend data for display on the user device. In some embodiments, the method 900 may further comprise retrieving stored sustainability metrics of similar farms; generating benchmarking data by comparing the one or more sustainability metrics of the farm against the sustainability metrics of similar farms; and outputting the benchmarking data for display on the user device.

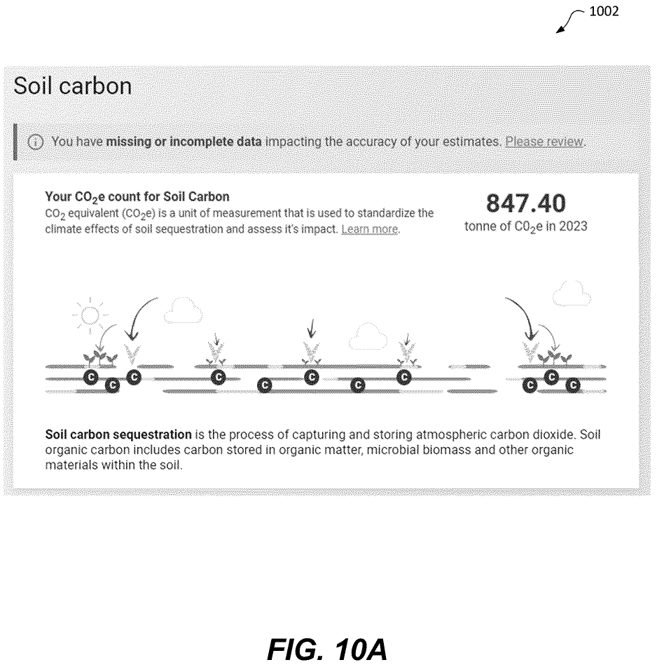

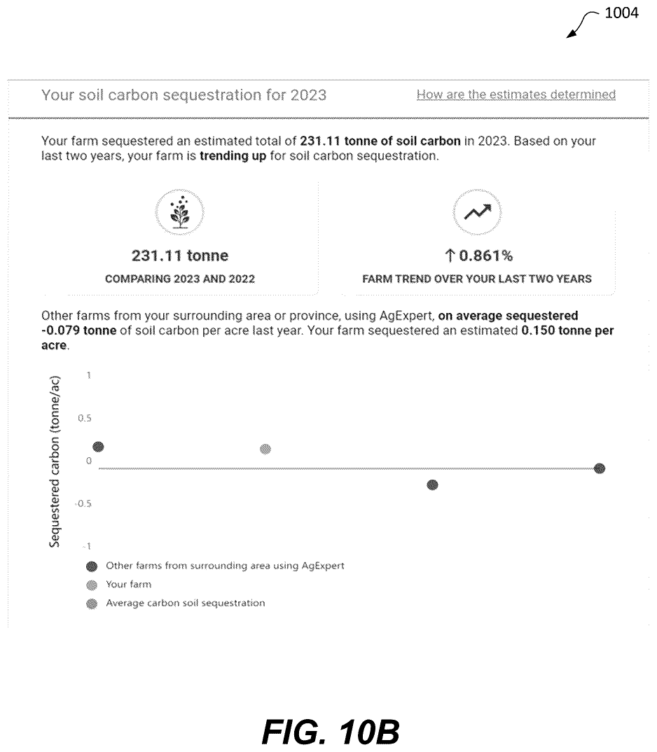

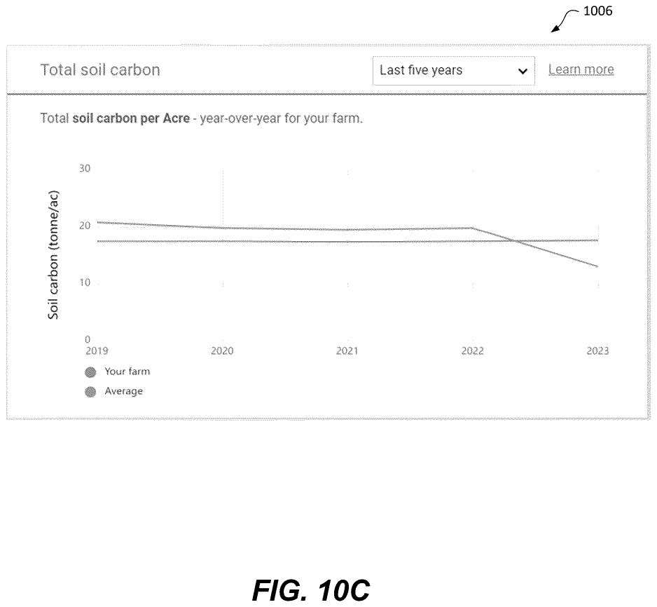

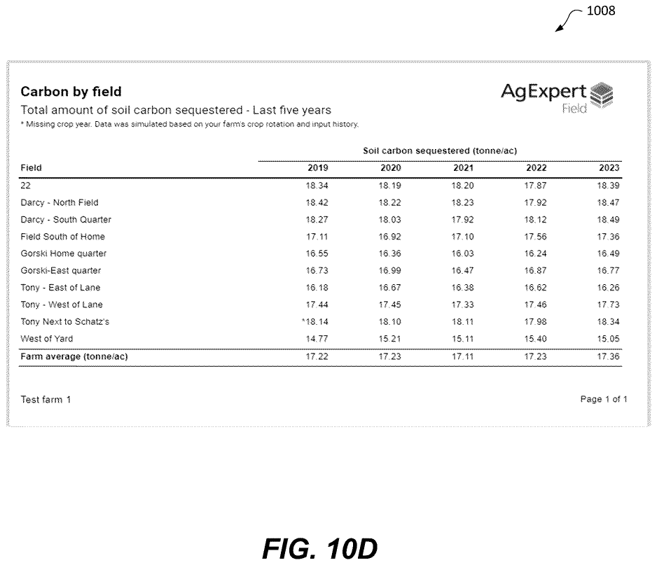

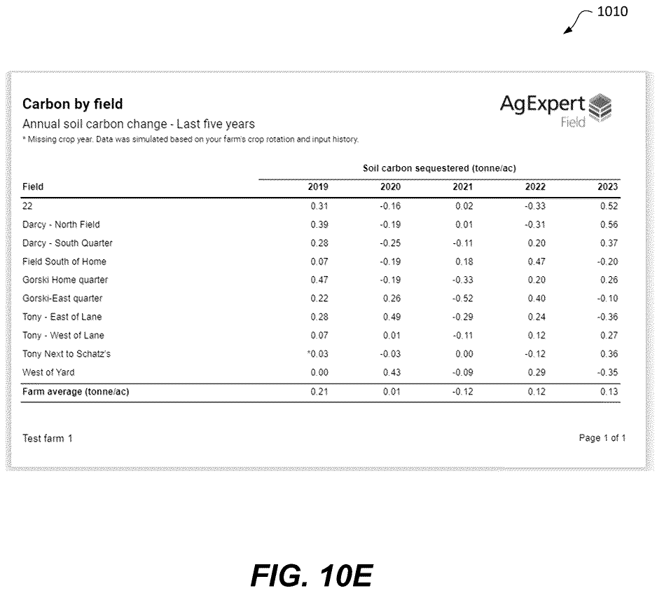

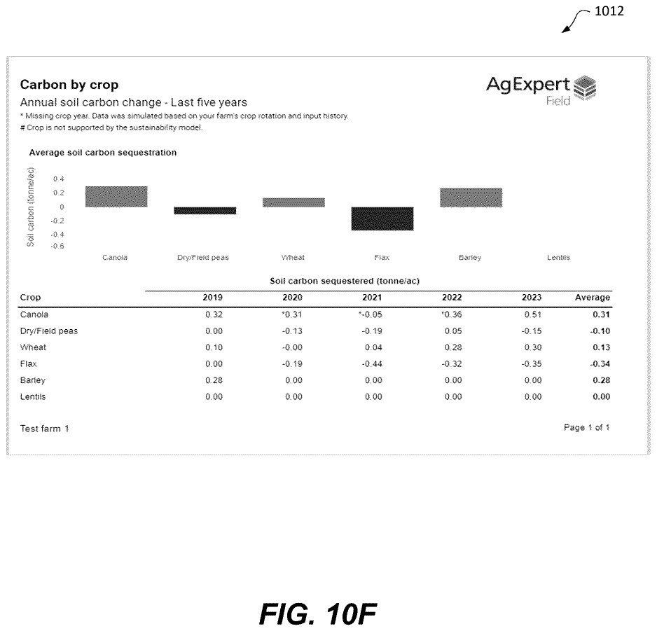

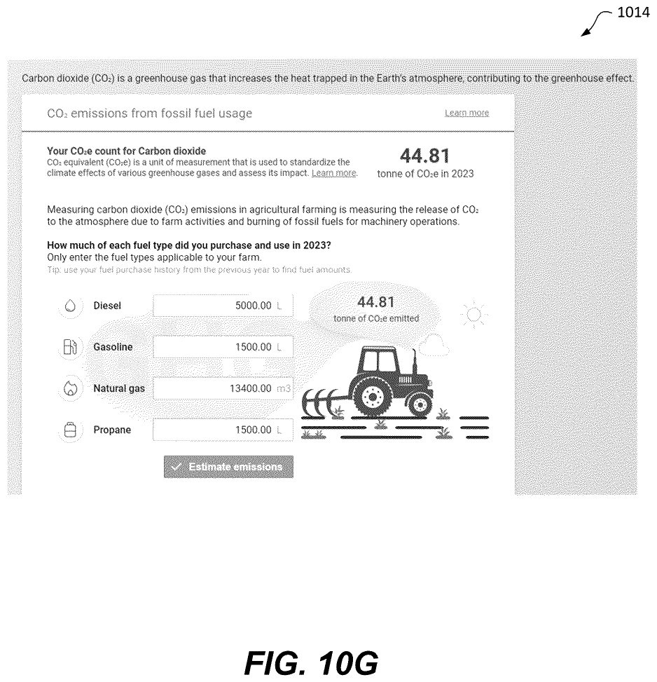

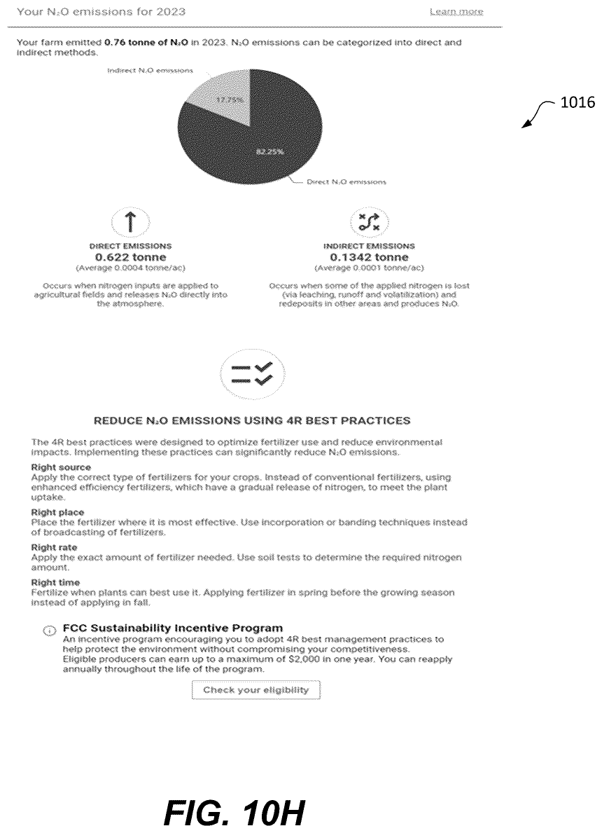

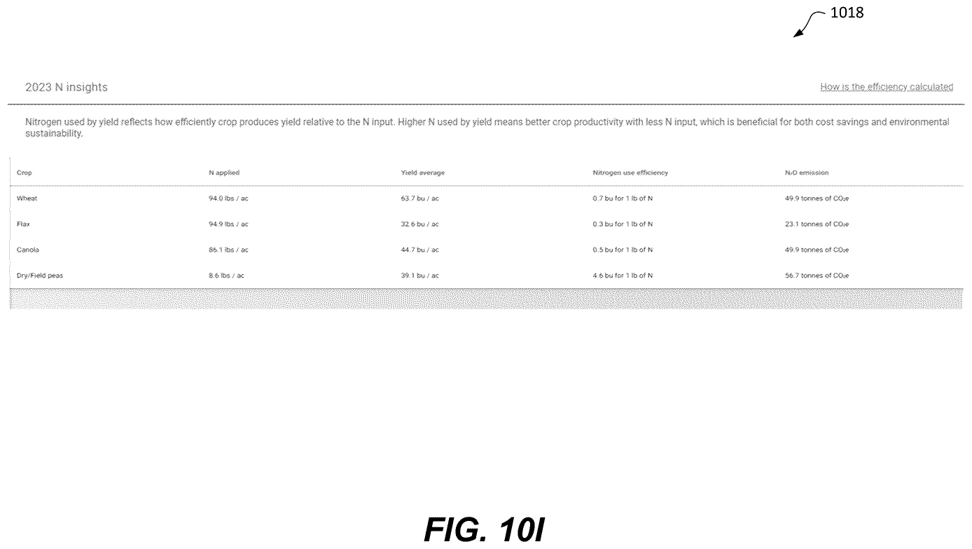

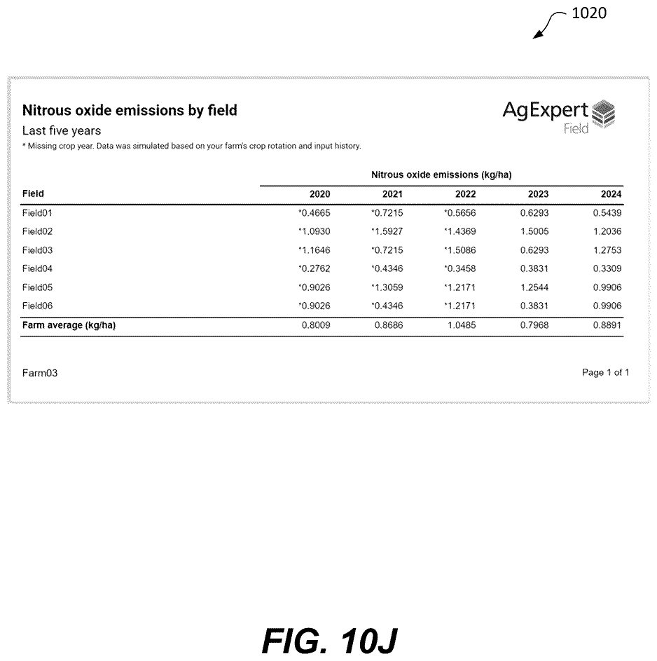

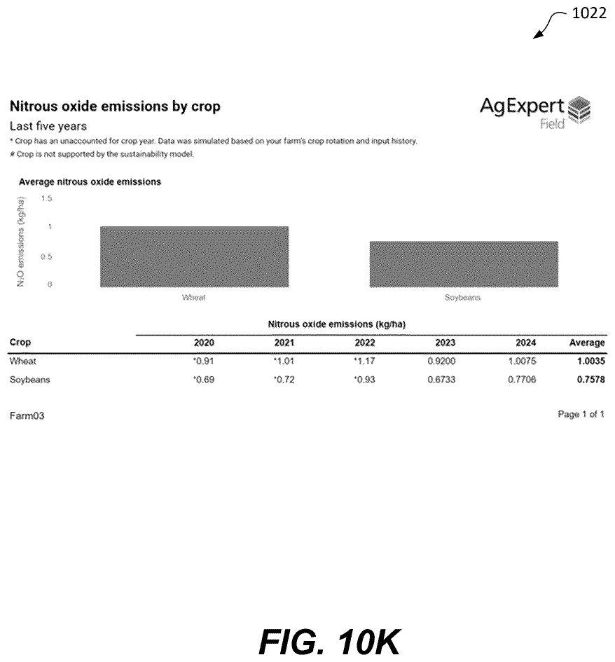

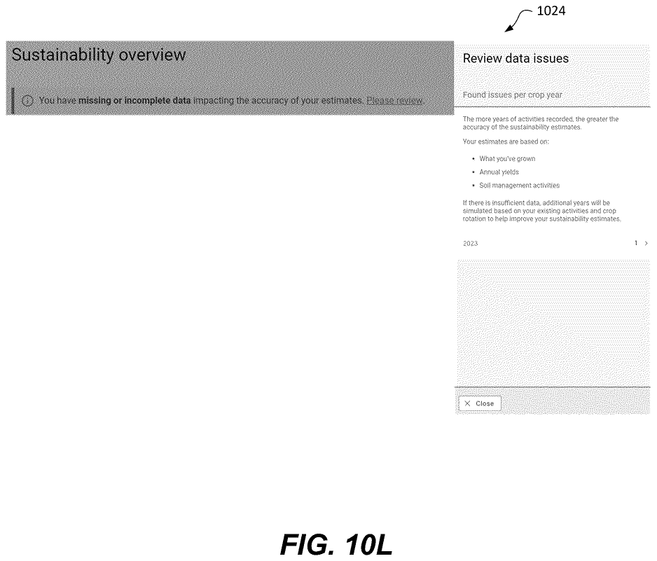

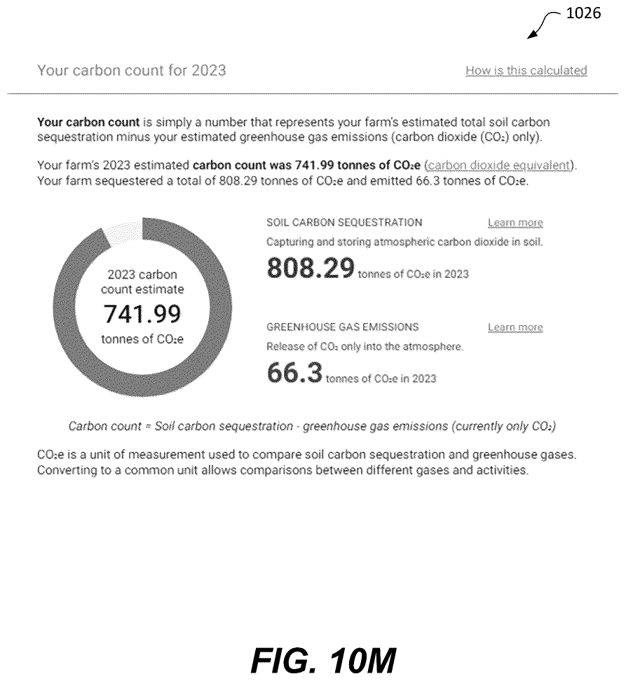

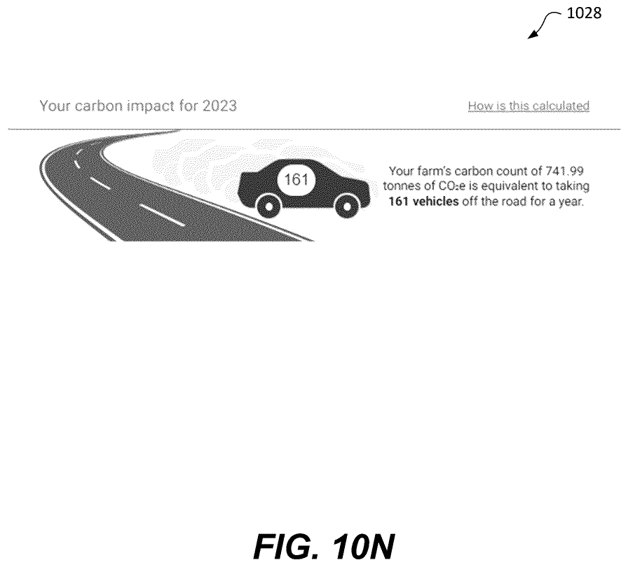

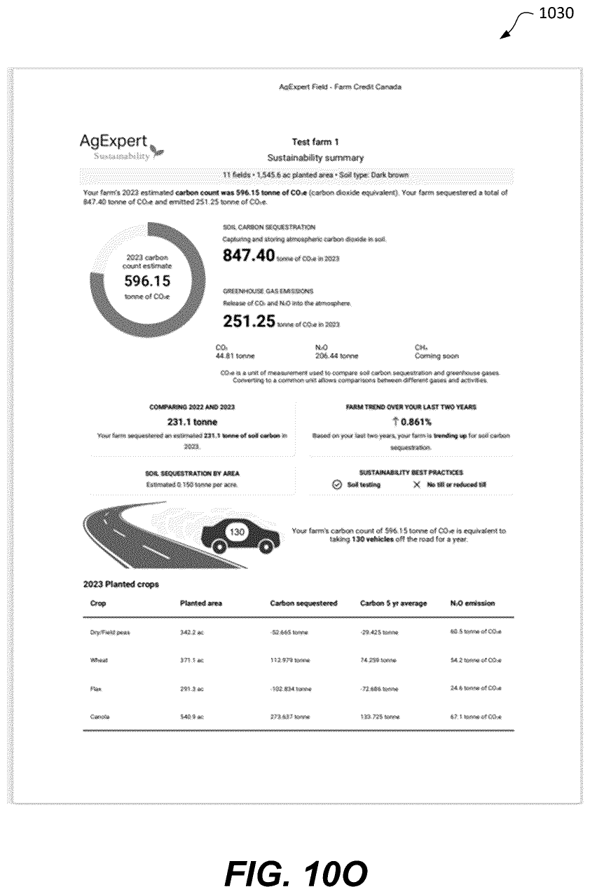

It will thus be appreciated that a variety of calculations may be made in accordance with the present disclosure and a variety of outputs can be generated for presentation to users. Various examples of user interfaces that may be displayed on user devices to users of the system described herein are shown in FIGS. 10A to 100. It will be appreciated that the examples of user interfaces are non-limiting and provided for the sake of example only to highlight various aspects of the functionality provided by the systems and methods in accordance with the present disclosure.

FIG. 10A shows an example of a user interface 1002 that shows a current year carbon sequestration estimation.

FIG. 10B shows an example of a user interface 1004 that shows a carbon sequestration analysis two-year comparison, farm trend, farm averages, and carbon sequestration of other farms from the surrounding area.

FIG. 10C shows an example of a user interface 1006 that shows year-over-yea soil carbon for the farm and regional averages.

FIG. 10D shows an example of a user interface 1008 that shows a Carbon by field report. The output may provide the total carbon sequestered by all fields in the farm over a 5 year, 10 year and full estimated history.

FIG. 10E shows another example of a user interface 1010 that shows a Carbon by field report as an annual carbon change by all fields in the farm, which may be provided over various time periods.

FIG. 10F shows an example of a user interface 1012 that shows a carbon sequestration by crop type over a 5 year period.

FIG. 10G shows an example of a user interface 1014 that receives fuel type inputs and outputs carbon dioxide emission estimates based on fuel usage.

FIG. 10H shows an example of a user interface 1016 that shows nitrous oxide emissions for a current year, including direct and indirect nitrous oxide emissions, and reduction strategies with best practices.

FIG. 10I shows an example of a user interface 1018 that shows nitrogen insights, include usage, yield, N used by yield, and nitrous oxide emissions across crop types.

FIG. 10J shows an example of a user interface 1020 that shows nitrous oxide emissions by field report over a 5 year period.

FIG. 10K shows an example of a user interface 1022 that shows nitrous oxide emissions by crop type over a 5 year period.

FIG. 10L shows an example of a user interface 1024 that may be displayed to a user suggesting that the user review and correct missing or incomplete data to ensure accurate estimates.

FIG. 10M shows an example of a user interface 1026 showing carbon count of the whole farm.

FIG. 10N shows an example of a user interface 1028 visually depicting a carbon impact of the farm.

FIG. 10O shows an example of a user interface 1030 displaying a summary report of sustainability information.

It would be appreciated by one of ordinary skill in the art that the system and components shown in the figures may include components not shown in the drawings. For simplicity and clarity of the illustration, elements in the figures are not necessarily to scale and are only schematic. It will be apparent to persons skilled in the art that a number of variations and modifications can be made without departing from the scope of the invention as described herein.

It is contemplated that any part of any aspect or embodiment discussed in this specification can be implemented or combined with any part of any other aspect or embodiment discussed in this specification, so long as such those parts are not mutually exclusive with each other.

It should be recognized that features and aspects of the various examples provided above can be combined into further examples that also fall within the scope of the present disclosure.

When used in this specification and claims, the terms “comprises” and “comprising” and variations thereof mean that the specified features, steps or integers are included. The terms are not to be interpreted to exclude the presence of other features, steps or components. Additionally, the term “connect” and variants of it such as “connected”, “connects”, and “connecting” as used in this description are intended to include indirect and direct connections unless otherwise indicated. For example, if a first device is connected to a second device, that coupling may be through a direct connection or through an indirect connection via other devices and connections. Similarly, if the first device is communicatively connected to the second device, communication may be through a direct connection or through an indirect connection via other devices and connections. Further, the singular forms “a”, “an”, and “the” are intended to include the plural forms as well, unless the context clearly indicates otherwise.

The embodiments have been described above with reference to flow, sequence, and block diagrams of methods, apparatuses, systems, and computer program products. In this regard, the depicted flow, sequence, and block diagrams illustrate the architecture, functionality, and operation of implementations of various embodiments. For instance, each block of the flow and block diagrams and operation in the sequence diagrams may represent a module, segment, or portion of code, which comprises one or more executable instructions for implementing the specified action(s). In some alternative embodiments, the action(s) noted in that block or operation may occur out of the order noted in those figures. For example, two blocks or operations shown in succession may, in some embodiments, be executed substantially concurrently, or the blocks or operations may sometimes be executed in the reverse order, depending upon the functionality involved. Some specific examples of the foregoing have been noted above but those noted examples are not necessarily the only examples. Each block of the flow and block diagrams and operation of the sequence diagrams, and combinations of those blocks and operations, may be implemented by special purpose hardware-based systems that perform the specified functions or acts, or combinations of special purpose hardware and computer instructions.

Use of language such as “at least one of X, Y, and Z,” “at least one of X, Y, or Z,” “at least one or more of X, Y, and Z,” “at least one or more of X, Y, and/or Z,” or “at least one of X, Y, and/or Z,” is intended to be inclusive of both a single item (e.g., just X, or just Y, or just Z) and multiple items (e.g., {X and Y}, {X and Z}, {Y and Z}, or {X, Y, and Z}). The phrase “at least one of” and similar phrases are not intended to convey a requirement that each possible item must be present, although each possible item may be present.

The invention may also broadly consist in the parts, elements, steps, examples and/or features referred to or indicated in the specification individually or collectively in any and all combinations of two or more said parts, elements, steps, examples and/or features. In particular, one or more features in any of the embodiments described herein may be combined with one or more features from any other embodiment(s) described herein.

1. A method for evaluating a sustainability metric of a farm, comprising:
receiving, from a user device, one or more first data inputs associated with the farm;
obtaining, from an external device via an application programming interface, one or more second data inputs associated with the farm;
obtaining, from a third party data source, one or more third data inputs associated with the farm;
calculating, using at least one sustainability calculation model, one or more sustainability metrics of the farm based on the one or more first data inputs, the one or more second data inputs, and the one or more third data inputs; and
outputting the one or more sustainability metrics for display on the user device.

2. The method of claim 1, wherein the at least one sustainability calculation model comprises: a carbon sequestration model, a N₂O emission model, a CO₂ emission model, a CH₄ emission model, or a combination thereof; and wherein the one or more sustainability metrics is one or more of a carbon sequestration, a N₂O emission, a CO₂ emission, and a CH₄ emission of the farm.

3. The method of claim 2, further comprising:
calculating a carbon balance for the farm based on the carbon sequestration, the N₂O emission, the CO₂ emission, and the CH₄ emission.

4. The method of claim 1, further comprising standardizing the one or more first data inputs, the one or more second data inputs, and/or the one or more third data inputs by mapping input data types to a standardized data type for use in the at least one sustainability calculation model.

5. The method of claim 1, wherein the one or more first data inputs comprise manually entered data and/or imported data.

6. The method of claim 1, wherein the one or more first data inputs comprise: agriculture activity data, crop field data, crop data, livestock data, or combinations thereof.

7. The method of claim 1, further comprising determining a suggested improvement that a user can make to the one or more first data inputs, and outputting the suggested improvement for display on the user device prior to calculating the one or more sustainability metrics.

8. The method of claim 7, wherein determining the suggested improvement comprises:
identifying one or more missing values from the first data inputs; and
prompting the user to input the one or more missing values.

9. The method of claim 7, wherein determining the suggested improvement comprises:
comparing the one or more first data inputs to pre-defined threshold values; and
prompting the user to revise a value of the one or more first data inputs when the value is determined to be outside the pre-defined threshold values.

10. The method of claim 1, wherein the external device comprises: farm equipment, a vehicle, a satellite, a sensor, an Internet of Things (IoT) device, a third party computing device, or combinations thereof.

11. The method of claim 1, wherein the one or more second data inputs comprises: fuel data, weather data, soil data, or combinations thereof.

12. The method of claim 1, wherein the one or more third data inputs comprise: crop product data, seed product data, legal land descriptions, or combinations thereof.

13. The method of claim 1, further comprising:
storing the one or more sustainability metrics in a database;
generating trend data of the one or more sustainably metrics for the farm over time; and
outputting the trend data for display on the user device.

14. The method claim 1, further comprising:
retrieving stored sustainability metrics of similar farms;
generating benchmarking data by comparing the one or more sustainability metrics of the farm against the sustainability metrics of similar farms; and
outputting the benchmarking data for display on the user device.

15. The method of claim 1, wherein the second data inputs and the third data inputs are obtained automatically.

16. A system for evaluating a sustainability metric of a farm, comprising:
a processor; and
a non-transitory computer-readable medium having computer-executable instructions stored thereon which, when executed by the processor, configure the system to:
receive, from a user device, one or more first data inputs associated with the farm;
obtain, from an external device via an application programming interface, one or more second data inputs associated with the farm;
obtain, from a third party data source, one or more third data inputs associated with the farm;
calculate, using at least one sustainability calculation model, one or more sustainability metrics of the farm based on the one or more first data inputs, the one or more second data inputs, and the one or more third data inputs; and
output the one or more sustainability metrics for display on the user device.

17. The system of claim 16, further comprising a database storing the one or more sustainability metrics calculated for the farm.

18. The system of claim 17, wherein the database further stores the one or more first data inputs, the one or more second data inputs, and the one or more third data inputs.

19. The system of claim 17, wherein the database further stores sustainability metrics for a plurality of farms.

20. A non-transitory computer-readable medium having computer-executable instructions stored thereon which, when executed by a processor, configure the processor to:
receive, from a user device, one or more first data inputs associated with the farm;
obtain, from an external device via an application programming interface, one or more second data inputs associated with the farm;
obtain, from a third party data source, one or more third data inputs associated with the farm;
calculate, using at least one sustainability calculation model, one or more sustainability metrics of the farm based on the one or more first data inputs, the one or more second data inputs, and the one or more third data inputs; and
output the one or more sustainability metrics for display on the user device.
